(19) United States
(12) Patent Application Publication
(10) Pub. No.: US 2026/0329411 A1
(43) Pub. Date: Oct. 22, 2026

(54) SYSTEMS AND METHODS FOR ENABLING INTERACTION WITH AN EXTENDED REALITY USER INTERFACE USING A WEARABLE DEVICE

(71) Applicant: Isovist Limited, London (GB)

(72) Inventors: Dale A. HERIGSTAD, London (GB); Jack TURPIN, Los Angeles, CA (US); Eric FANGHANEL SANTIBANEZ, London (GB)

(21) Appl. No.: 19/724,633

(22) Filed: Jun. 29, 2026

Related U.S. Application Data
(63) Continuation-in-part of application No. 19/040,727, filed on Jan. 29, 2025.
Application No. 19/040,727 is a continuation of application No. 18/444,179, filed on Feb. 16, 2024, now Pat. No. 12,248,654.

(51) Int. Cl. G06F 3/04815; G06F 3/01; G06F 3/0482; G06F 3/0485; G06F 3/0488

(52) U.S. Cl. CPC G06F 3/04815; G06F 3/017; G06F 3/0482; G06F 3/0485; G06F 3/0488; G06F 2203/04808

(57) ABSTRACT

A system generates multiple virtual zones on an extended reality user interface displayed by a computing device. Sensor data, including electromyography (EMG) readings from EMG sensors and inertial measurement data from an inertial measurement unit (IMU), is received from a wearable device attached to a user's limb. The system identifies a multi-finger grip configuration based on EMG data, which involves co-activation of specific finger combinations. Each identified grip configuration is mapped to a corresponding virtual zone, with different grips linked to distinct zones. While the grip is maintained, the system detects user gestures using inertial data and executes interaction actions within the target virtual zone based on these gestures.

### CROSS-REFERENCE TO RELATED APPLICATIONS

This application is a continuation-in-part application of U.S. Non-Provisional application Ser. No. 19/040,727, filed on Jan. 29, 2025, which is a continuation of U.S. Non-Provisional application Ser. No. 18/444,179, filed Feb. 16, 2024, both of which are herein incorporated by reference.

### FIELD OF TECHNOLOGY

The present disclosure relates to the field of extended reality technologies, and, more specifically, to systems and methods for generating and enabling interaction with an extended reality user interface.

### BACKGROUND

Augmented reality (AR), virtual reality (VR), and mixed reality (MR) represent a transformative wave of technological innovation that intertwines the digital and physical worlds. These extended reality technologies seamlessly blend computer-generated content with a real-world environments. The complexity of AR/VR/MR arises from the interplay of hardware and software components required to create immersive and convincing visuals. On the hardware front, sophisticated sensors, cameras, and display systems work in tandem to accurately capture eye/hand motion and also recreate the user's surroundings. Simultaneously, robust software algorithms process vast amounts of data in real-time, enabling precise tracking of movements and interactions.

Despite the capabilities of extended reality technologies in rendering complex visuals with an increasingly high number of interactable visual elements, such technologies struggle to provide user interfaces that enable ease of access to said visual elements and natural/instinctual interaction. Even in situations with a large number of interactable visual elements, conventional user interfaces employ clunky reach and grab/touch motions that often translate improperly in the digital environment and result in incorrect selections. The poor-performance user interfaces are a result of limits in hardware and software. For example, onboard sensors may be unable to accurately discern depth and positional differences between crowded visual elements (especially in three-dimensional elements disposed at varying lengths that give the illusion of overlap from the camera perspective). In another example, poorly written user interface code may expend great memory and processing power unnecessarily to execute reach and grab motions in crowded digital environments. This reduces the resources available to perform other software features (e.g., rendering visual elements) and ultimately leads to inefficient execution of the extended reality software.

### SUMMARY

While camera-based and touchscreen-based gesture detection systems provide effective means for capturing user inputs in extended reality environments, such systems may be limited in certain use cases. For example, camera-based gesture detection requires a line of sight between the camera and the surface on which the gesture is performed, and may be degraded by poor lighting conditions, occlusion, or rapid user movement. Similarly, touchscreen-based gesture detection requires the user to carry or remain near a peripheral device with a touch-sensitive display. As extended reality applications become increasingly mobile and are used in a wider variety of physical environments, there is a need for input modalities that do not depend on camera-based visual tracking or physical touchscreens and that enable reliable gesture detection regardless of the user's location, posture, or environmental conditions. Wearable devices equipped with physiological and inertial sensors present an opportunity to address these limitations by enabling gesture detection directly from the user's body without requiring any external surface or camera observation.

In one exemplary aspect, the techniques described herein relate to a method for generating and enabling interaction with an extended reality user interface using a wearable device, the method including: generating, on an extended reality user interface displayed by a computing device, a plurality of virtual zones; receiving, from a wearable device worn on a limb of a user, sensor data including electromyography (EMG) data from an array of EMG sensors and inertial measurement data from an inertial measurement unit (IMU); identifying, based on the EMG data, a multi-finger grip configuration performed by the user, wherein the multi-finger grip configuration includes a co-activation of a particular combination of fingers of the user; mapping the identified multi-finger grip configuration to a target virtual zone of the plurality of virtual zones, wherein different multi-finger grip configurations are mapped to different virtual zones of the plurality of virtual zones; detecting, based on the inertial measurement data received while the multi-finger grip configuration is maintained, a gesture performed by the user; and executing an interaction action on the target virtual zone based on the detected gesture.

In some aspects, the techniques described herein relate to a method, wherein the multi-finger grip configuration is a first multi-finger grip configuration including a co-activation of a thumb and an index finger, and the target virtual zone is a first virtual zone, and wherein the method further includes: identifying, based on the EMG data, a second multi-finger grip configuration including a co-activation of the thumb, the index finger, and a middle finger; and mapping the second multi-finger grip configuration to a second virtual zone of the plurality of virtual zones that is different from the first virtual zone.

In some aspects, the techniques described herein relate to a method, wherein each progressively larger multi-finger grip configuration that includes an additional co-activated finger is mapped to a different virtual zone of the plurality of virtual zones.

In some aspects, the techniques described herein relate to a method, wherein the gesture is a scroll gesture, and wherein detecting the gesture includes: detecting, via the IMU, an angular velocity spike along a pitch axis exceeding a threshold magnitude within a threshold duration, and wherein executing the interaction action includes sliding a plurality of selectable elements displayed in the target virtual zone along a vertical axis in a direction corresponding to a direction of the angular velocity spike.

In some aspects, the techniques described herein relate to a method, wherein the gesture is a rotation gesture, and wherein detecting the gesture includes: detecting, via the IMU, sustained angular velocity along a roll axis or a yaw axis while the EMG data confirms that the multi-finger grip configuration is maintained, and wherein executing the interaction action includes rotating an element displayed in the target virtual zone in a direction and by an amount indicated by an angular displacement measured by the IMU.

In some aspects, the techniques described herein relate to a method, wherein the gesture is a selection gesture, and wherein detecting the gesture includes: detecting, via the EMG data, a release of the multi-finger grip configuration followed by two successive re-engagements of the multi-finger grip configuration within a defined time window, and wherein executing the interaction action includes selecting an element currently within a fixed visual indicator of the target virtual zone.

In some aspects, the techniques described herein relate to a method, wherein the gesture is a zoom gesture, and wherein detecting the gesture includes: detecting, via the EMG data, a substantially simultaneous decline in EMG amplitude across all co-activated finger compartments from a sustained co-activation state to respective relaxation thresholds within a defined transition window, and wherein executing the interaction action includes applying a zoom-out action to an element displayed in the target virtual zone, wherein a magnitude of the zoom-out action is proportional to a rate of the decline in EMG amplitude.

In some aspects, the techniques described herein relate to a method, further including: classifying a gesture-zone pair based on the EMG data and the inertial measurement data using a classification algorithm, wherein the gesture-zone pair includes the target virtual zone and the detected gesture; and transmitting, from the wearable device to the computing device, a structured input event including the gesture-zone pair, wherein the computing device executes the interaction action based on the structured input event without performing image processing or camera-based gesture recognition.

In some aspects, the techniques described herein relate to a method, further including: in response to identifying the multi-finger grip configuration, providing feedback to the user indicating the target virtual zone, wherein the feedback includes one or more of: a visual emphasis applied to the target virtual zone on the extended reality user interface, an auditory tone associated with the target virtual zone, and a haptic vibration pattern produced by the wearable device.

In some aspects, the techniques described herein relate to a method, further including: prior to receiving the sensor data from the wearable device, receiving user inputs via a camera-based detection system that detects gestures performed on a physical surface; detecting that the physical surface is no longer accessible; and in response to detecting that the physical surface is no longer accessible, transitioning an input modality from the camera-based detection system to the wearable device, wherein a state of the extended reality user interface is preserved across the transition.

In some aspects, the techniques described herein relate to a system for generating and enabling interaction with an extended reality user interface, including: at least one memory; and at least one hardware processor coupled with the at least one memory and configured, individually or in combination, to: generate, on an extended reality user interface displayed by a computing device, a plurality of virtual zones; receive, from a wearable device worn on a limb of a user, sensor data including electromyography (EMG) data from an array of EMG sensors and inertial measurement data from an inertial measurement unit (IMU); identify, based on the EMG data, a multi-finger grip configuration performed by the user, wherein the multi-finger grip configuration includes a co-activation of a particular combination of fingers of the user; map the identified multi-finger grip configuration to a target virtual zone of the plurality of virtual zones, wherein different multi-finger grip configurations are mapped to different virtual zones of the plurality of virtual zones; detect, based on the inertial measurement data received while the multi-finger grip configuration is maintained, a gesture performed by the user; and execute an interaction action on the target virtual zone based on the detected gesture.

In some aspects, the techniques described herein relate to a non-transitory computer readable medium storing thereon computer executable instructions for generating and enabling interaction with an extended reality user interface, including instructions for: generating, on an extended reality user interface displayed by a computing device, a plurality of virtual zones; receiving, from a wearable device worn on a limb of a user, sensor data including electromyography (EMG) data from an array of EMG sensors and inertial measurement data from an inertial measurement unit (IMU); identifying, based on the EMG data, a multi-finger grip configuration performed by the user, wherein the multi-finger grip configuration includes a co-activation of a particular combination of fingers of the user; mapping the identified multi-finger grip configuration to a target virtual zone of the plurality of virtual zones, wherein different multi-finger grip configurations are mapped to different virtual zones of the plurality of virtual zones; detecting, based on the inertial measurement data received while the multi-finger grip configuration is maintained, a gesture performed by the user; and executing an interaction action on the target virtual zone based on the detected gesture.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating an extended reality device.

FIG. 2 is a block diagram illustrating a computing device capable of outputting VR and AR visuals.

FIG. 3A illustrates a diagram of a software application with complex visual elements.

FIG. 3B illustrates a diagram of a user input executed on the software application with complex visual elements.

FIG. 4 illustrates a diagram of an exemplary zone user interface.

FIG. 5 illustrates an the software application of FIG. 3A executed in an extended reality setting.

FIG. 6 illustrates a diagram of an exemplary zone user interface employed in an extended reality setting.

FIG. 7 illustrates variations of an application space definer used in the exemplary user interface of the present disclosure.

FIG. 8 illustrates navigation panels and interaction proxies used in the exemplary user interface of the present disclosure.

FIG. 9A-9E illustrate various gestures for navigating the exemplary user interface of the present disclosure.

FIGS. 10A-10F illustrate isometric views of navigating an operating system using the exemplary user interface of the present disclosure.

FIGS. 11A-11E illustrate user perspective views corresponding to the isometric views shown in FIGS. 10A-10E.

FIGS. 12A-12F illustrate an example of navigation through another software application executed in an extended reality setting using the exemplary user interface.

FIG. 13 illustrates mapping of the input-receiving elements of the user interface on a palm surface.

FIG. 14 illustrates mapping of the input-receiving elements of the user interface on a hard surface.

FIG. 15 illustrates mapping of the input-receiving elements of the user interface on a virtual interface.

FIG. 16 illustrates touch areas/physical zones associated with zones on a virtual interface.

FIG. 17 is a flow diagram illustrating a method for generating and enabling interaction with an extended reality user interface.

FIG. 18 is a diagram illustrating a wristband with a plurality of sensors worn on a forearm of a user.

FIG. 19 illustrates a two-finger pinch gesture between a thumb and an index finger of a user and a mapping of the two-finger pinch gesture to a zone of the extended reality user interface.

FIG. 20A illustrates a translation of a hand maintaining the two-finger pinch gesture from a first position to a second position in three-dimensional space.

FIG. 20B illustrates an upward flick gesture performed by a hand maintaining the two-finger pinch gesture.

FIG. 20C illustrates a rotation gesture performed by a hand maintaining the two-finger pinch gesture from a first orientation to a second orientation.

FIG. 21 illustrates a three-finger pinch gesture and a mapping of the three-finger pinch gesture to a zone of the extended reality user interface.

FIG. 22 illustrates a full-hand pinch gesture and a mapping of the full-hand pinch gesture to a zone of the extended reality user interface.

FIG. 23 illustrates an alternative grip configuration in which a thumb of a user is tucked under curled fingers of the hand.

FIG. 24 illustrates a zoom gesture in which a hand transitions from a full-hand pinch configuration to an open-hand configuration with all fingers extended.

FIG. 25 illustrates a flow diagram of a method for generating and enabling interaction with an extended reality user interface using a wearable device.

### DETAILED DESCRIPTION

Exemplary aspects are described herein in the context of a system, method, and computer program product for generating and enabling interaction with an extended reality user interface. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

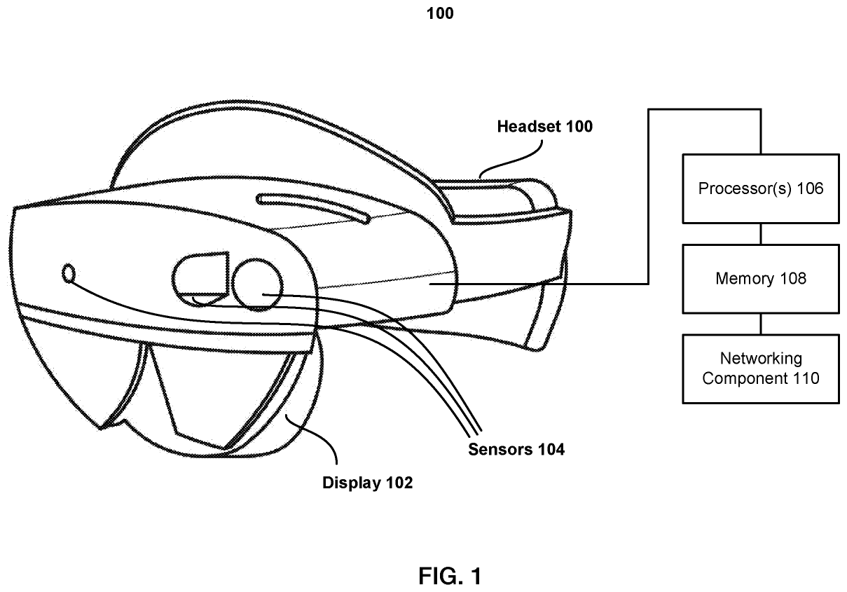

FIG. 1 is a block diagram illustrating an extended reality device 100. Extended reality device 100 may include one or more hardware processors 106 couple with one or more memories 108 that execute and store instructions (e.g., code) of extended reality user interface module 101 (XR UI module 101). XR UI module 101 may be part of an extended reality software application and is configured to generate and enable interaction with an extended reality user interface.

Extended reality device 100 may further include networking component 110, which enables wired and/or wireless communication with other devices (e.g., enables a Wi-Fi or Bluetooth connection with other device(s) such as a smartphone). In some aspects, extended reality device 100 may be a headset that incudes sensors 104 (e.g., infrared sensor, laser, camera, accelerometer, gyroscope, etc.). When worn, one of sensors 104 (e.g., a laser) may project visuals on display 102. In some aspects, display 102 may be a transparent surface that enables the user to view the physical environment and the visuals projected onto display 102 simultaneously and seamlessly. In other aspects, display 102 may be a non-transparent display comprising a plurality of pixels. In this approach, display 102 may present a visual of the physical environment (e.g., an output of a camera feed) and the visuals of the extended reality user interface using the pixels of display 102.

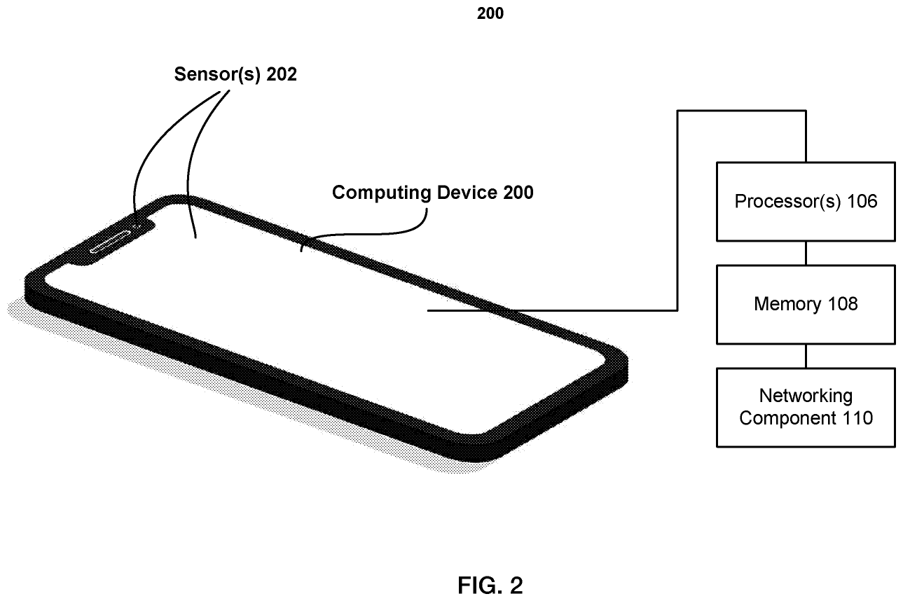

FIG. 2 is a block diagram illustrating a computing device 200 capable of outputting VR and AR visuals. In some aspects, rather than using a headset, a user may use computing device 200 (e.g., a smartphone) to access an extended reality user interface. Computing device 200 includes hardware processor(s) 106, memory 108, and networking component 110 and executes XR UI module 101. Similarly to extended reality device 100, computing device 200 may include sensor(s) 202 such as a camera, a touch-sensitive layer of display 204, an accelerometer, etc. In an exemplary aspect, display 204 is a non-transparent display comprising a plurality of pixels. Display 204 may present a visual of the physical environment (e.g., an output of a camera feed) and the visuals of the extended reality user interface using the pixels of display 204.

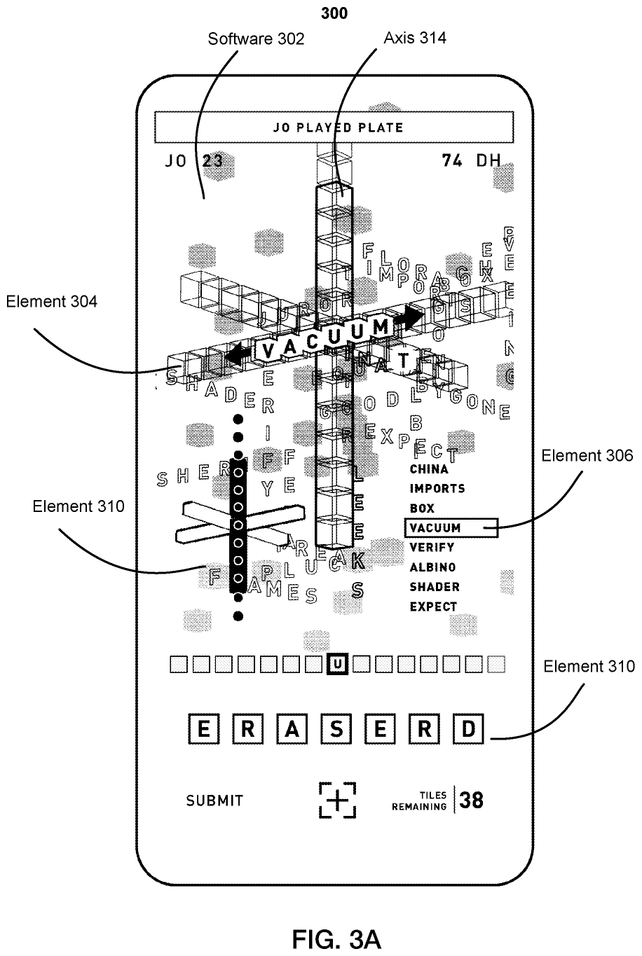

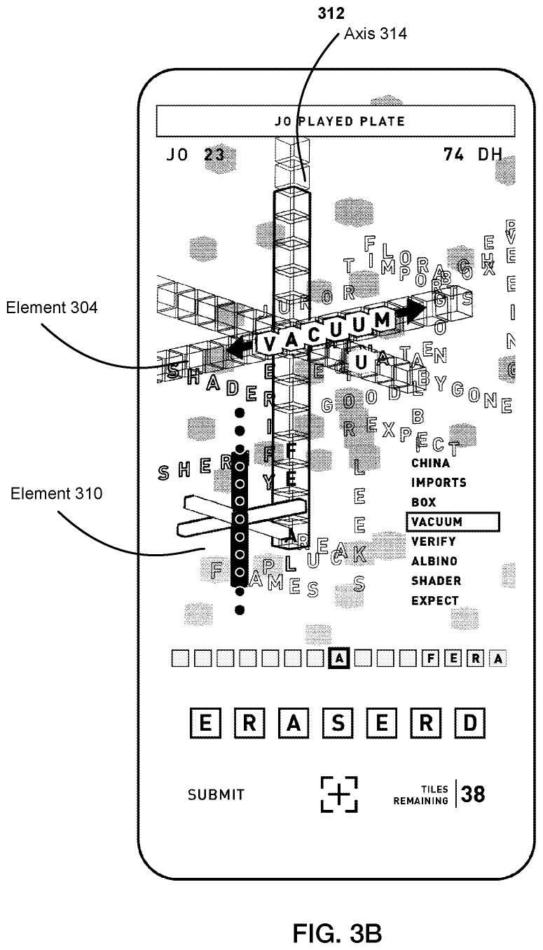

FIG. 3A illustrates a diagram 300 of a software 302 (e.g., a software application) with complex visual elements. FIG. 3B illustrates a diagram 312 of a user input executed on the software application with complex visual elements.

Software 302 is a volumetric game of Scrabble™. The term “volumetric” indicates that the game is played on a cubic structure (e.g., 15 letter cubes by 15 letter cubes by 15 letter cubes in which there are 3375 potential letter cubes for use in word plays. Each letter in the cube has a unique position (e.g., (X, Y, Z) in an XYZ-plane). Due to the amount and complexity of visuals in software 302, if the interface requires a user to select each block individually, the user experience would be poor. For example, the user would likely select a block that he/she did not intend to select, and may waste time in an attempt to perform basic game functions. Because a user cannot simply select, with high accuracy, a random block with a traditional point-and-select approach, the first aspect of the present disclosure is proposed, namely, a zoned user interface.

Prior to describing the zoned user interface, consider the following elements in software 302: (1) element 304 presents a horizontal array of blocks that include the term “vacuum,” (2) element 306 includes a list of terms in the cubic structure, (3) element 308 includes letters that the user has to enter in the cubic structure, and (4) element 310 is a navigational proxy that enables the user to change an axis of element 304. For example, in FIG. 3A, the letter in the word “vacuum” along axis 314 is “u.” Suppose that the user shifts his/her finger on element 310 upward, the play position changes such that the letter in the word “vacuum” along axis 314 becomes “a.” This is shown in FIG. 3B. By using element 310 to adjust the axis associated with element 304, the user has more control as compared to selecting and dragging the term “vacuum.” A dragging command may be incomprehensible to software 302, which would not know whether element 304 is to be dragged inward, upward, downward, etc., and to what degree.

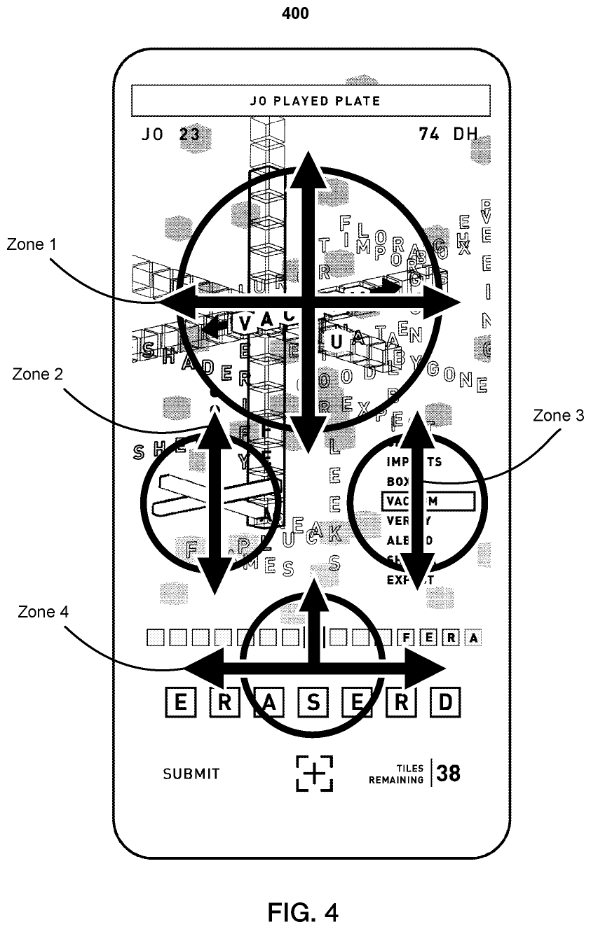

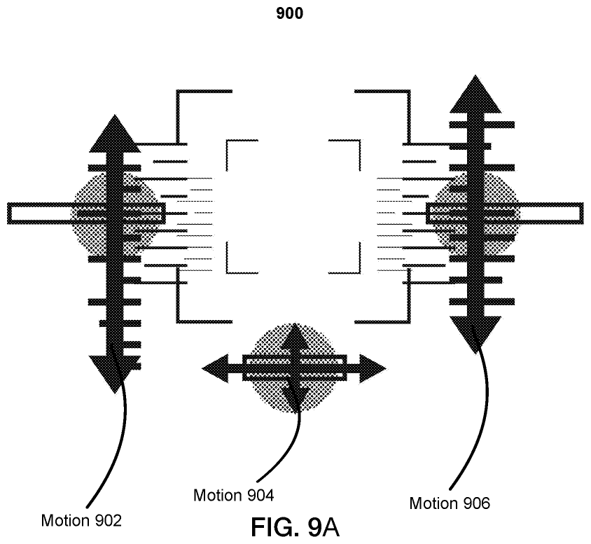

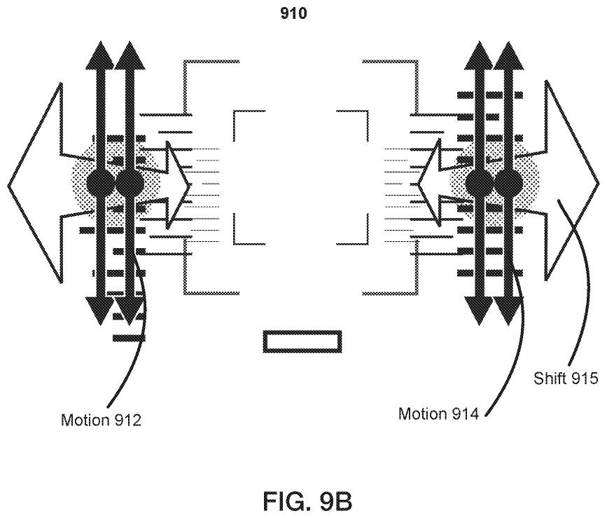

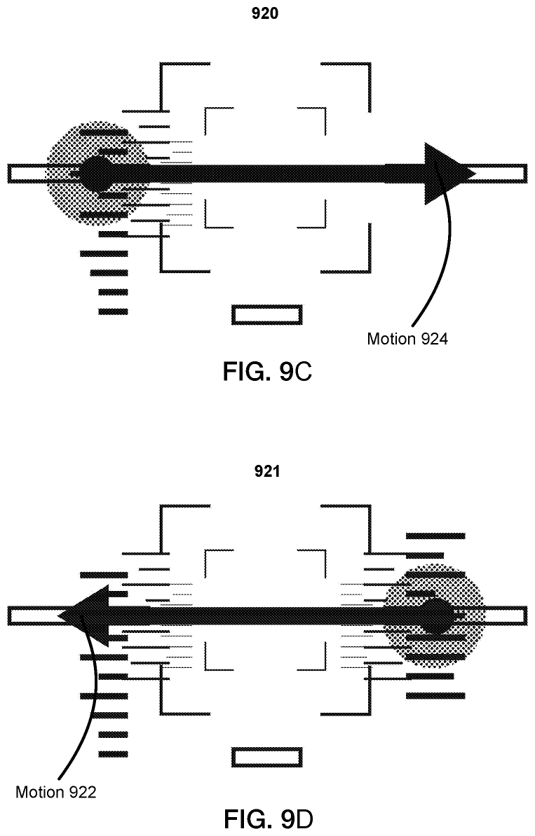

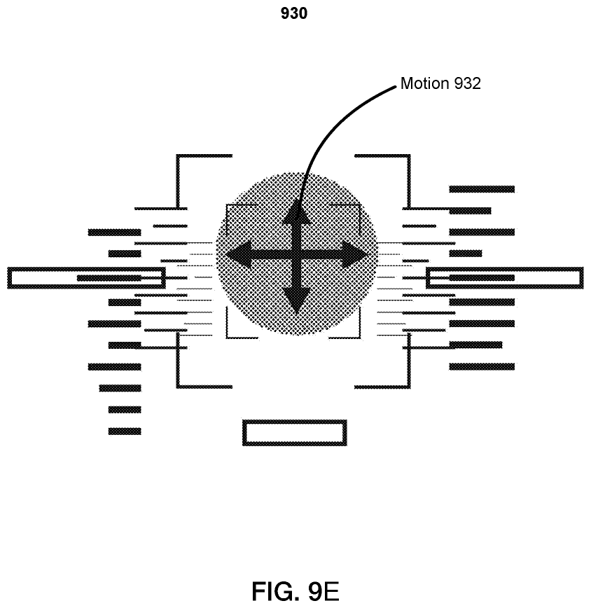

FIG. 4 illustrates a diagram 400 of an exemplary zone user interface generated by XR UI module 101. The zones include: primary zone 1, zone 2, zone 3, and zone 4. In a traditional user interface, the user simply interacts with primary zone 1 by selecting individual blocks in the cubic structure and performing rotations, scaling functions, etc. In the zone user interface, such functionality that would traditionally be performed on primary zone 1 is divided amongst zones 2, 3, and 4. As given in the previous example of FIGS. 3A and 3B, a user may interact with element 310 to change the axis associated with element 304. This is made possible by deferring the axis picking functionality to zone 2. Similarly, other actions such as word selection/navigation is deferred to zone 3, letter input is deferred to zone 4, etc. Depending on the software being executed, the functionality offered in each zone may change based on user interaction (will be discussed in the description of FIG. 9A-9C). Furthermore, although the arrows shown in each zone show how a user may interact with each zone, the manner of interaction may change based on the functionality. For example, zone 2 includes up and down arrows that suggest that the user may push up/down in that zone to select an axis.

Although only four zones are shown, one skilled in the art can appreciate that the amount of zones may increase or decrease depending on the software being executed. In a preferable aspect, four zones allows for a user to interact with the user interface almost instinctively (e.g., without looking). This is because four zones allow for a symmetric placement (e.g., left, right, up, down) of functionality that is well interpreted by the human mind. Additional zones may increase the complexity of the user interface as the user has to be more accurate with where he/she is providing an input gesture and recall additional mappings between functionality and zones. For example, if ten zones are introduced, not only does the user need to be mindful of what each zone does, but also be aware of where each zone is placed.

In some cases, having too few zones on the user interface can prevent quick and efficient navigation as well because the user will need to perform more interactions (e.g., gestures, button presses, etc.) to adjust the functionality of a zone and then subsequently execute the functionality. Referring to FIG. 4, if zone 2 is eliminated, the user will need to either interact directly with primary zone 1 (which poses the issues described previously), or will need to reset the functionality of zone 3 (e.g., to axis picking) and subsequently execute the functionality.

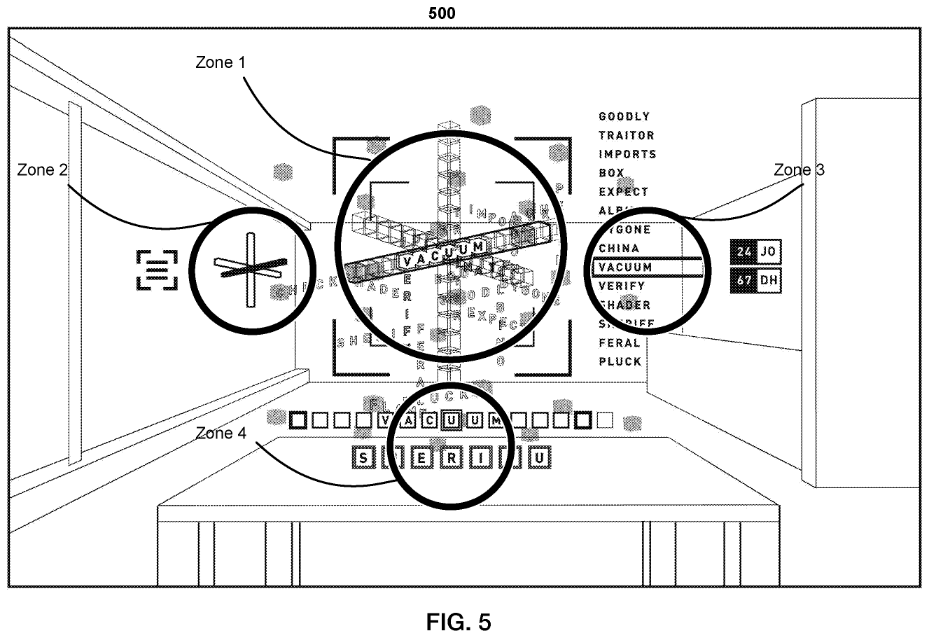

FIG. 5 illustrates an the software application of FIG. 3A executed in an extended reality setting using XR UI module 101. Up until now, the description of software 302 has been from the perspective of a 2D display (e.g., display 204 of computing device 200). In FIG. 5, the user interface of the volumetric game is shifted into a 3D setting. Zones 1, 2, 3, and 4 are carried over from FIG. 4. In the 3D environment, visual depth is added to the cubic structure. It should be noted that although the user will understand that the cubic structure in FIG. 4 is a volume which can be rotated to achieve different views, in FIG. 5, the user can see the 3D attributes of the cubic structure. This is enabled by the dual visual output generated on display 102, which gives the illusion of depth. It is in this 3D format where the motivation for the zone user interface is more apparent because the difficulty of selecting objects/elements at varying depths increases. The performance of the zone user interface described in FIG. 4 relieves this difficulty because, as mentioned before, the user no longer performs a variety of functions that poorly translate when depth is introduced, all in primary zone 1. It should be noted that in the XR interface of the present application, all graphic elements such as characters, words, lines, shapes, etc., are independent objects in space. Conventional XR interfaces may simply display a singular object (e.g., a screen) that is floating in space, in which case the elements shown on the screen are part of the same object. In contrast, the icons, lists, graphics, etc., shown in the present application float in space, are organized by arrangements, justification of type, and careful positioning. Each object has its own position in the x, y, z space.

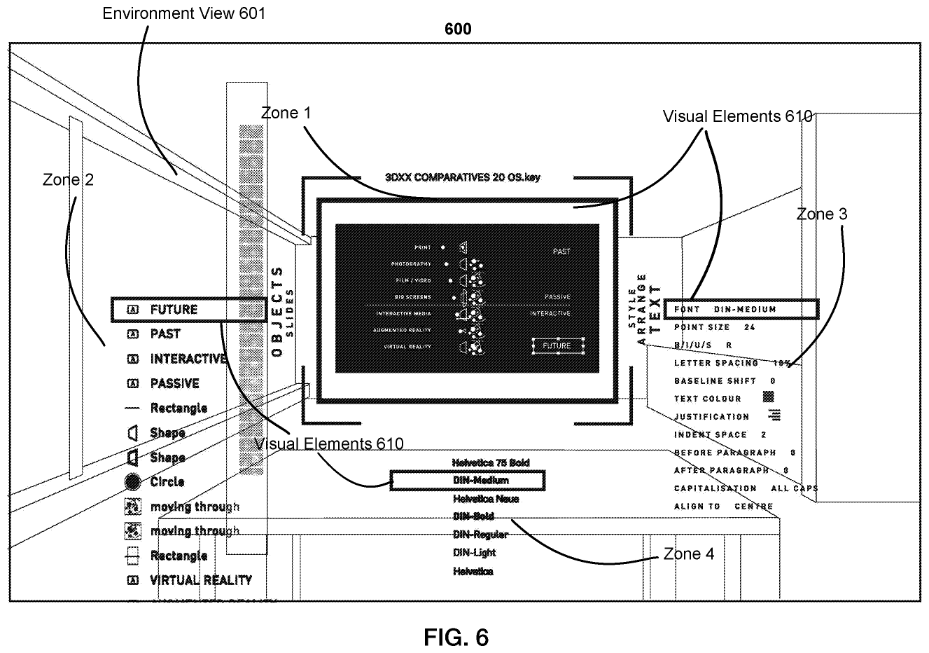

FIG. 6 illustrates a diagram of an exemplary zone user interface employed in an extended reality setting using the XR UI module 101. It should be noted that the zone user interface is applicable to various software applications. For example, in FIG. 6, the user is interacting with a different application (e.g., a slide editor such as Keynote™). Primary zone 1 depicts the focal point of the application (e.g., the slide currently being edited). In particular, primary zone 1 depicts the main image being edited/viewed. For example, in the three-dimensional word game, the cube is located in the primary zone. A user may interact with the element in primary zone (e.g., rotate the element to achieve different views). Zone 2 includes functionality such as a selector for various objects in the slide. For example, the user can scroll through the list of objects shown in zone 2, select an object, and that particular object will be selected in primary zone 1 (e.g., the text “Future” is selected by the user, which as a response, is highlighted in primary zone 1). Zone 3 includes functionality for editing the selected object in zone 2. For example, the user may scroll through the list of editable features and select “font,” to adjust the font of the text “Future.” Zone 4 includes functionality for editing the selected editable feature in zone 3. For example, zone 4 includes a list of selectable fonts. Visual elements 610 each show the current selection made by the user in each zone.

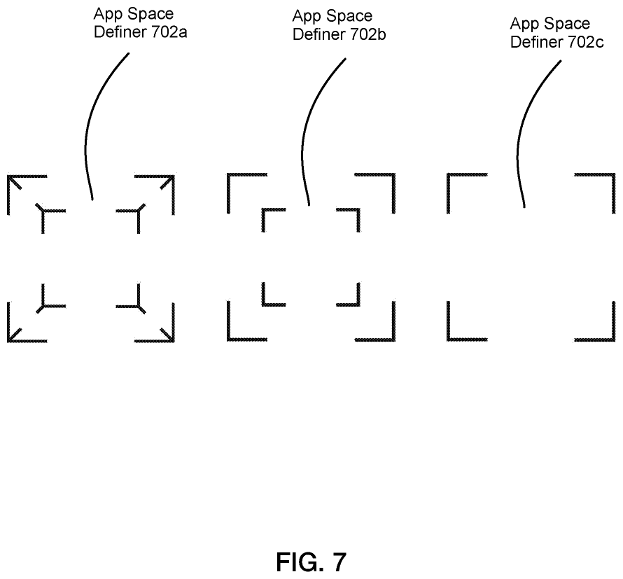

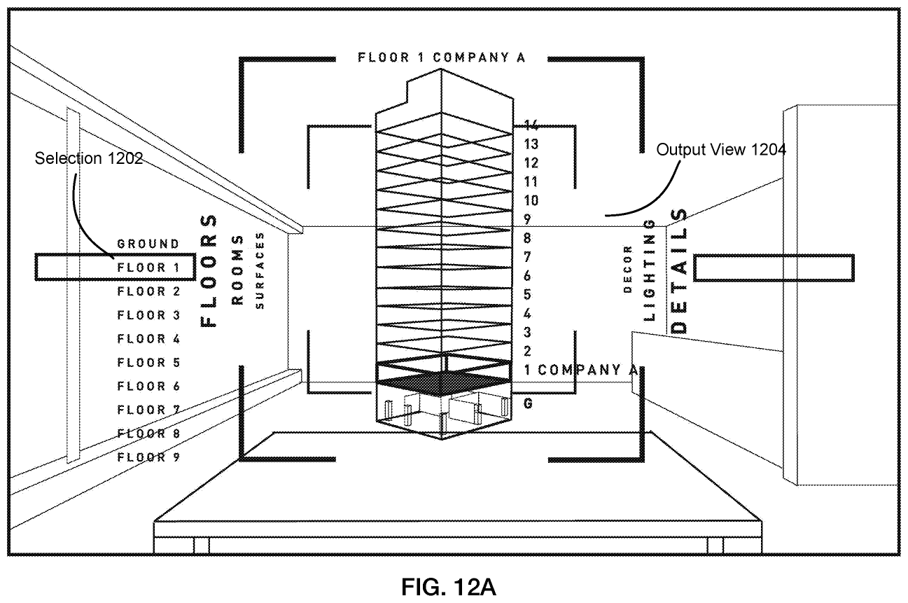

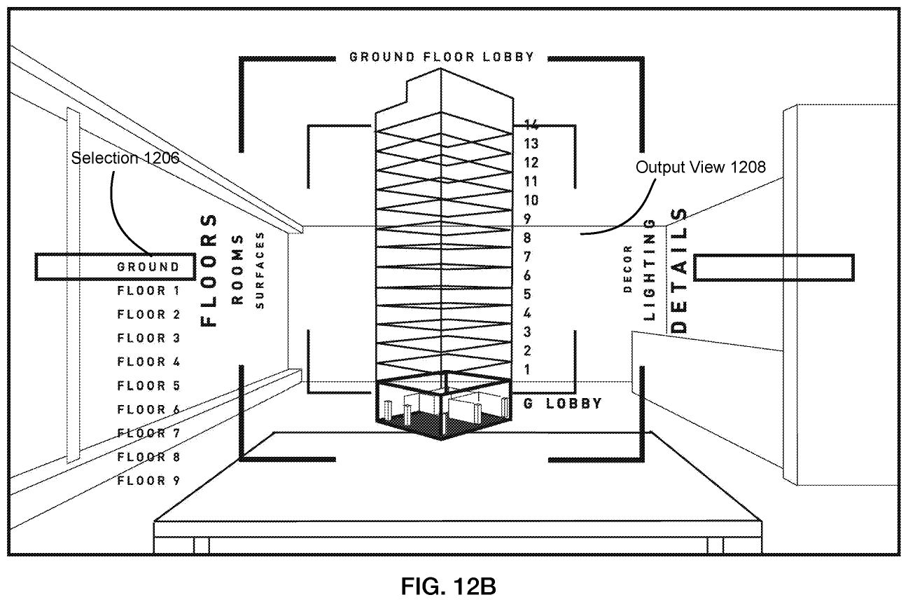

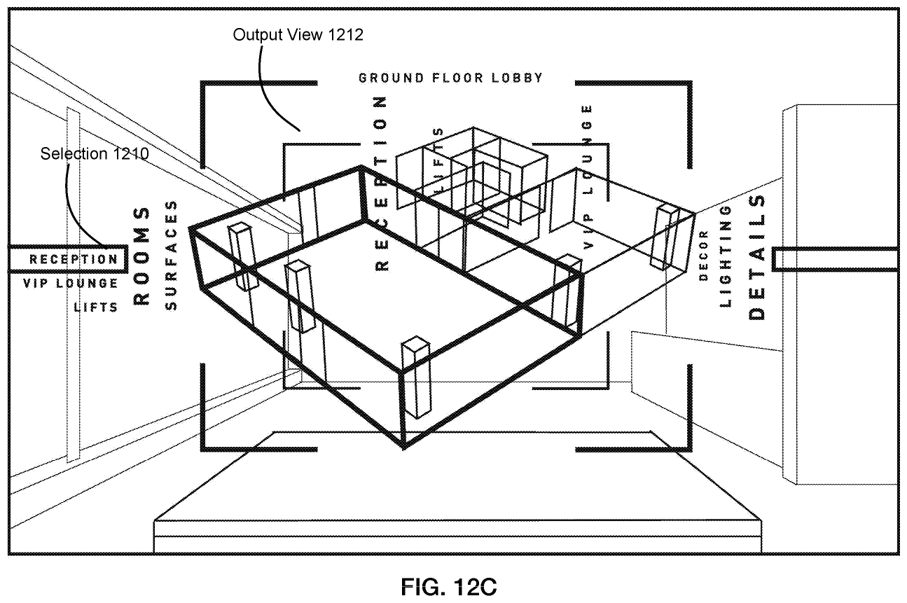

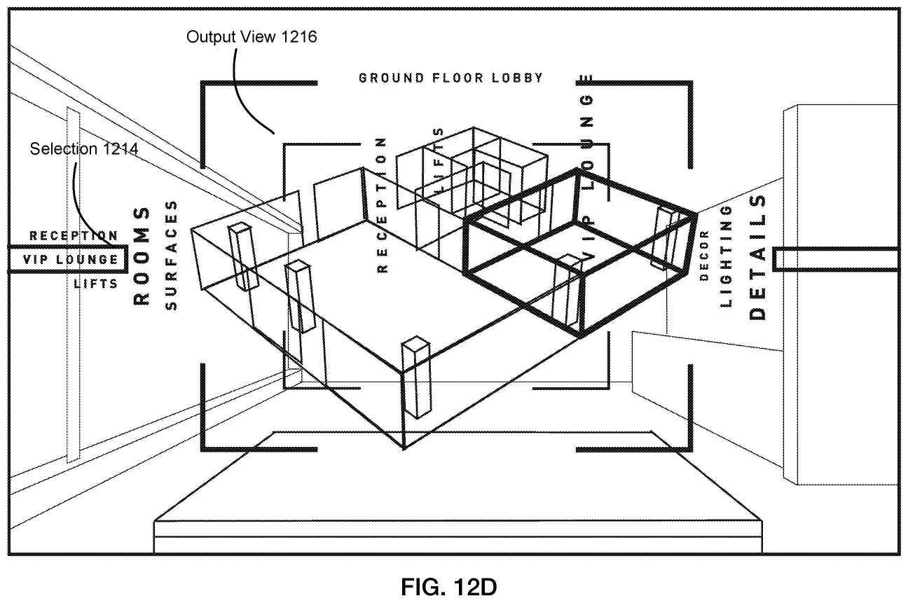

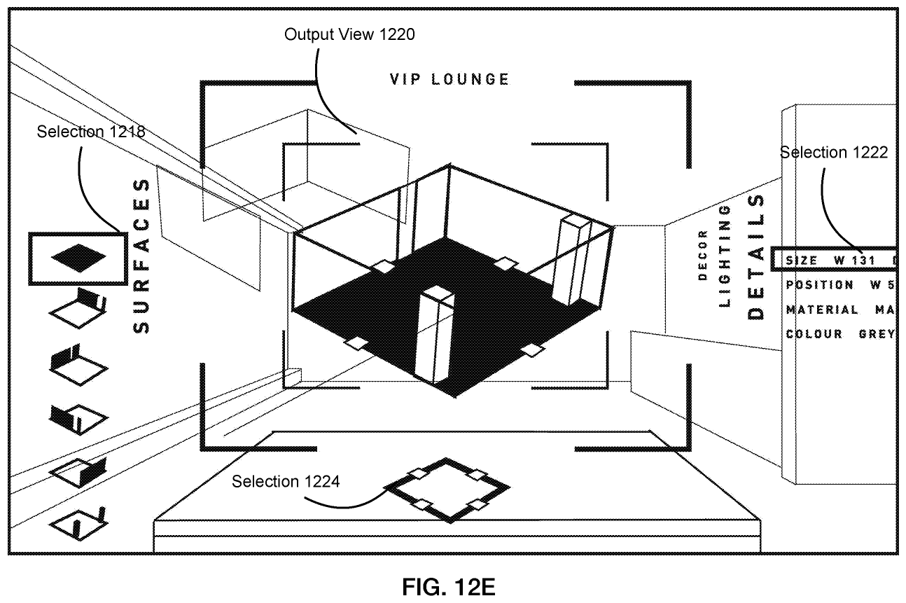

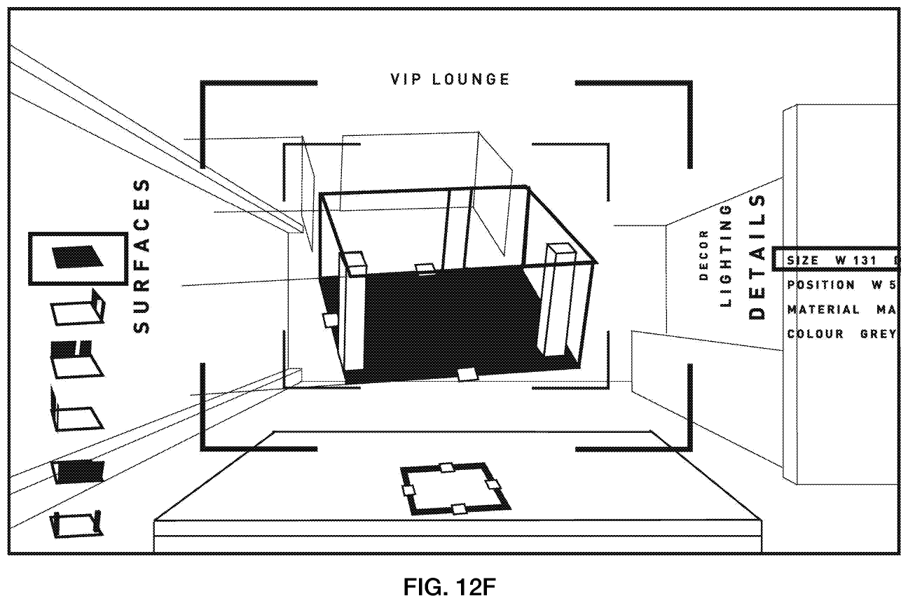

FIG. 7 illustrates variations of an application space definer (ASD) generated by the XR UI module 101. Each primary zone is bound by an application space definer. FIG. 7 depicts examples such as app space definer 702a and app space definer 702b, which both establish a depth of the application space for 3D visuals (e.g., the cubic structure in FIG. 5). App space definer 702c may be used for a 2D visual that does not have depth characteristics (e.g., the slide in FIG. 6). The height and width of the app space definer may change based on the visuals of the application being executed in the zone user interface. For example, in FIG. 12B and FIG. 12C, the app space definer has a different width because the objects being depicted have different dimensions.

In general, an ASD is a “loose” includeer of an application. The core elements are included within the space of the ASD, but relevant parts can extend beyond. An example is shown in FIG. 5, in which when zooming into a desired area that surrounds the selected word, the cubes that define the game cube are visible beyond the ASD. In the current world of windows (that include applications in two-dimensions) it is not possible to accommodate this extension beyond the edges of the window. But in fact, as in the case of FIG. 5, seeing the parts outside of the ASD is quite useful. In some aspects, the extended parts fade out over distance (e.g., 100 pixels) from the ASD so as to not form edges.

This particular array of three examples of the ASD is meant to show that there are various ways to graphically display the working area of an application or visual, although more variations may be contemplated. It is worth noting that the exact variation used can be considered to be part of the “brand” of the entity creating the application.

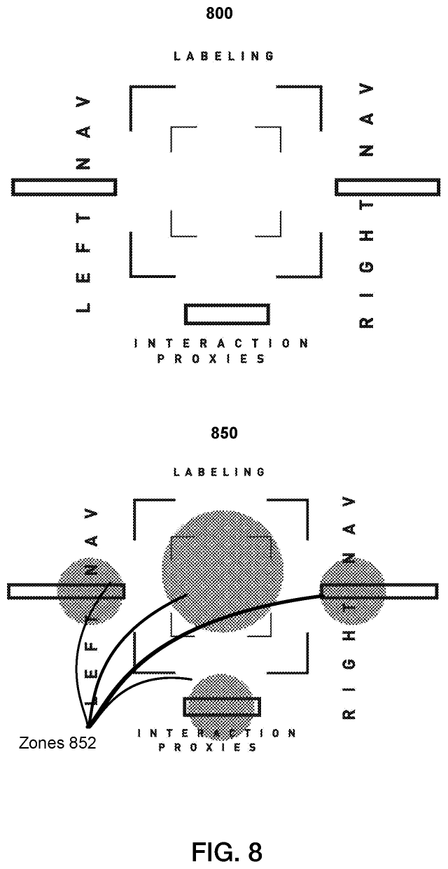

FIG. 8 illustrates navigation panels and interaction proxies generated by the XR UI module 101. The zone user interface 800 includes a left navigation zone, a primary zone, a right navigation zone, and interaction proxies. These zones are specifically located in this arrangement so as to be discernible without looking at the virtual interaction surface. Zone user interface 850 is an annotated version of zone user interface 800 and includes zones 852. In an exemplary aspect, zones 852 are not visually marked on the user interface. For example, the user's view will simply show zone user interface 800 (unless the user specifically requests to see where zones 852 are located). It should be noted that although each zone is shown as a circle, the area bound by each zone may be of any shape (e.g., a rectangle, an oval, etc.) and of any size (e.g., spanning an edge of the display to another edge) so long as the zones do not overlap.

As noted earlier, the zones represent the general spot where a gesture begins. As in where the “touch” is made. After the system identifies the zone, the user then moves up or down or left or right.

FIG. 9A-9E illustrate example gestures for navigating the exemplary user interface generated by the XR UI module 101. To perform any of the motions shown in FIGS. 9A-9E, the user touches an area in a given zone (generally aiming for a center of that zone) and then moves directionally in a particular motion. In FIG. 9A, zone user interface 900 is depicted in which the user may execute a gesture with motion 902 (up/down) to navigate a list in the left navigation zone. The user may execute a gesture with motion 904 (left/right/up/down) to navigate a list in the interaction proxies zone. The user may execute a gesture with motion 906 (up/down) to navigate a list in the right navigation zone. In some aspects, a gesture may involve moving a finger in a certain motion. This motion may be captured by a touch-sensitive display (e.g., display 204), or may be captured by a camera (e.g., in sensors 104 and/or sensors 202). In particular, the capture may be split into two parts: a touch or point at a particular zone, and then a subsequent motion (e.g., motion 906).

As mentioned previously, in an extended reality space, there may be a depth property of the zone user interface. In FIG. 9B, zone user interface 910 shows motions 912 and 914 for scrolling across different depth layers. For example, left navigation zone may have a list that spans multiple columns. As shown in FIG. 9B, each column is spaced at a different depth (the further the column is, the thinner its lines are in FIG. 9B). In order to bring a column in the back to the forefront, the user may execute a gesture of motion 912 (specifically motioning downward). In some aspects, the gesture may involve moving two fingers in motion 912 in zone 2 or motion 914 in zone 3. Based on this gesture, the columns may be traversed along the depth axis as shown by shift 915 (also applicable to columns in zone 2). The reasoning behind this motion is that two fingers swiped downward is like “pulling” an array closer to the user and two fingers swiped upward is like “pushing” the array away. In some aspects, the arrays may be arranged in a carousel such that pushing upward/downward in one direction restarts the display of the first array after all arrays have been navigated through the motion. This motion may also be captured by a touch-sensitive display (e.g., a touch screen), or may be captured by a camera.

In FIGS. 9C and 9D, zone user interfaces 920 and 921 show motions 924 and 922, respectively, for scrolling across different applications and application histories. For example, by executing a gesture associated with motion 922, the user can go “back” to a previous menu of the application or close an application. By executing a gesture associated with motion 924, the user can go “forward” to another menu of the application. The user may also switch between applications using said motions. In particular, motion 922 involves performing a gesture in which the finger of the user horizontally spans from the right navigation zone to the left navigation zone. Before an app is opened, users can make successive motions left to right (motion 924) allowing a hierarchical selection of arrays to open an application, and open a desired file. The user may make a “mental map” where left/right motions across zones 2 and 3 (represented here by motions 924 and 922) are reserved for traversing to and across the hierarchical layout of applications and the finder.

In an exemplary aspect, the capture of the motion on the touch screen and/or by a camera is broken into two parts. In the first part, the user “touches” a location on a particular zone. In the second part, the user swipes in a particular direction. For example, when performing motion 924, the user selects a location in zone 2 and swipes towards the right.

FIG. 9E illustrates zone user interface 930 in which motion 932 is executed in primary zone 1. Motion 932 allows a user to, for example, rotate/enlarge/shrink an element (e.g., the main focal element) in primary zone 1.

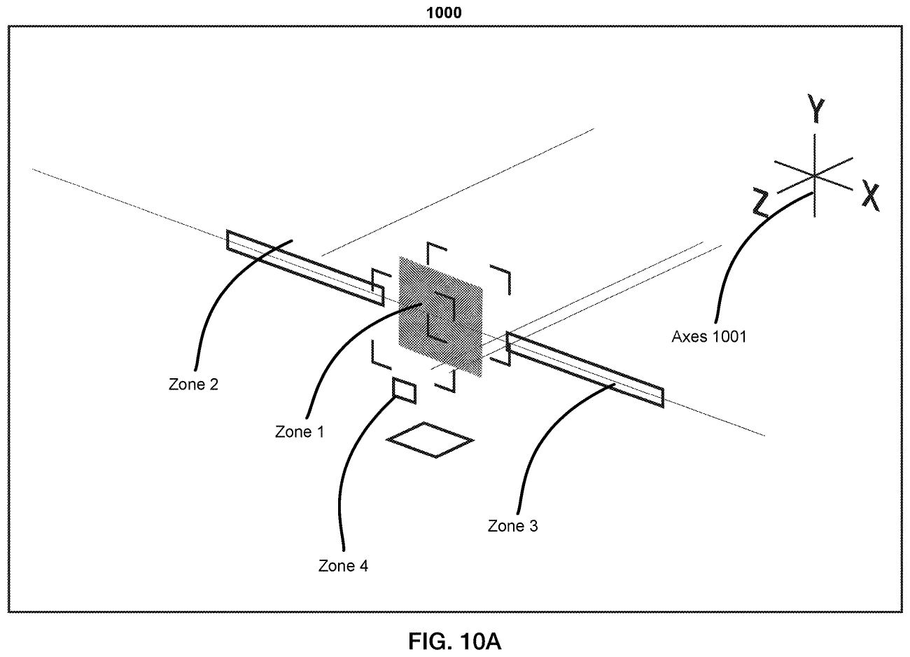

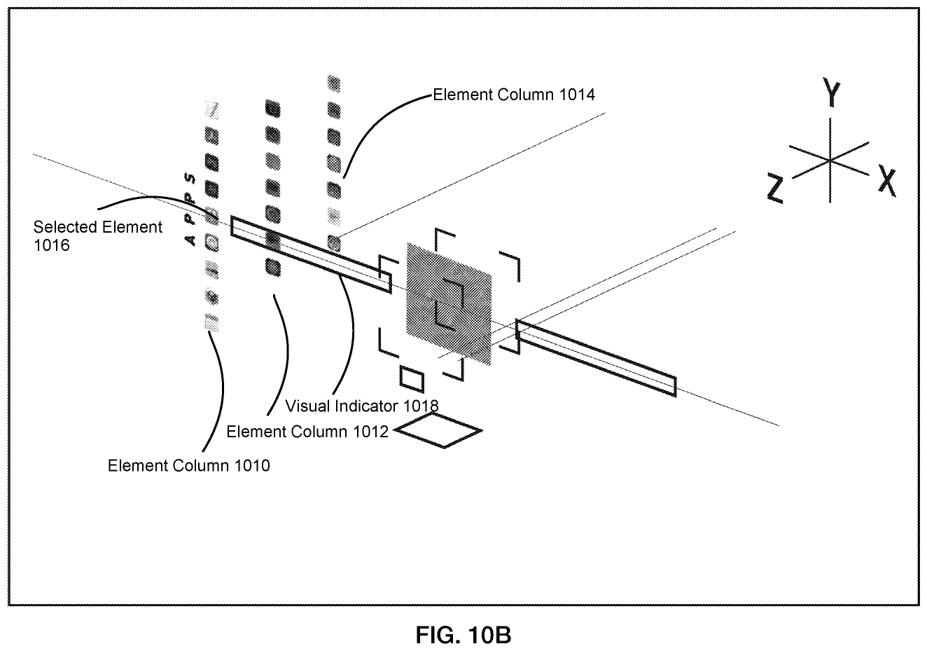

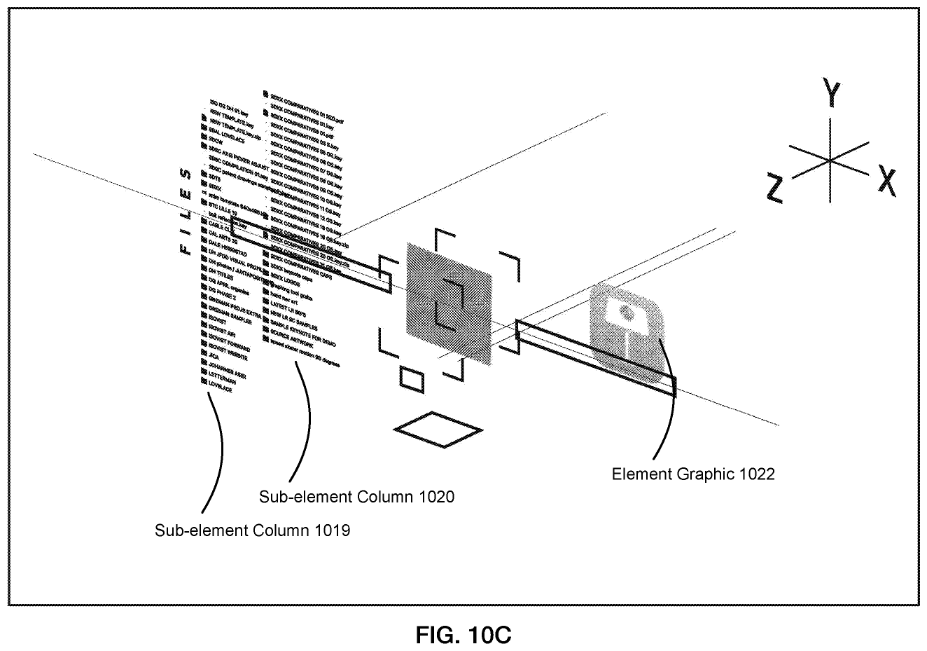

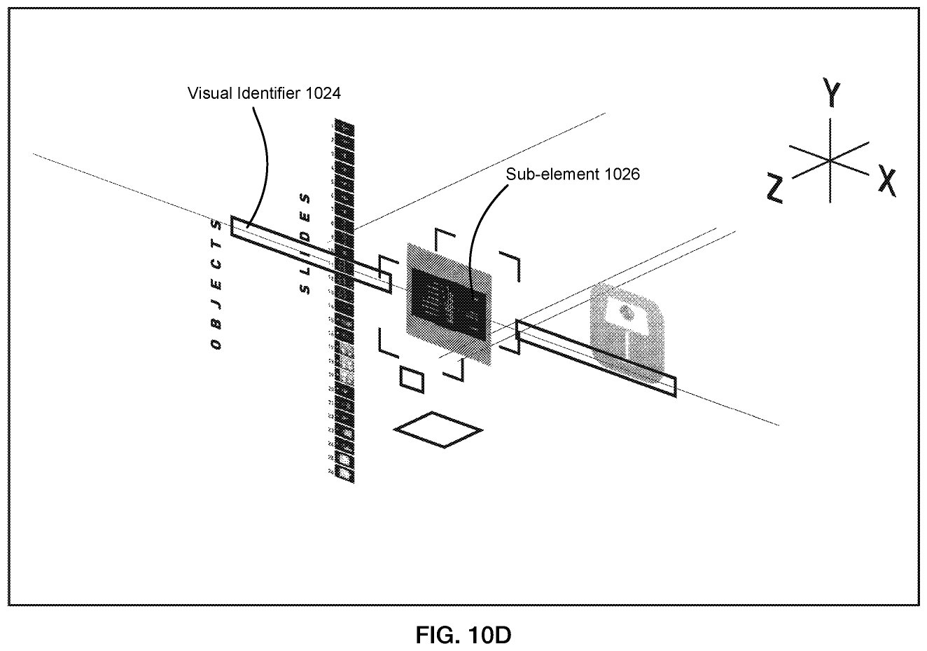

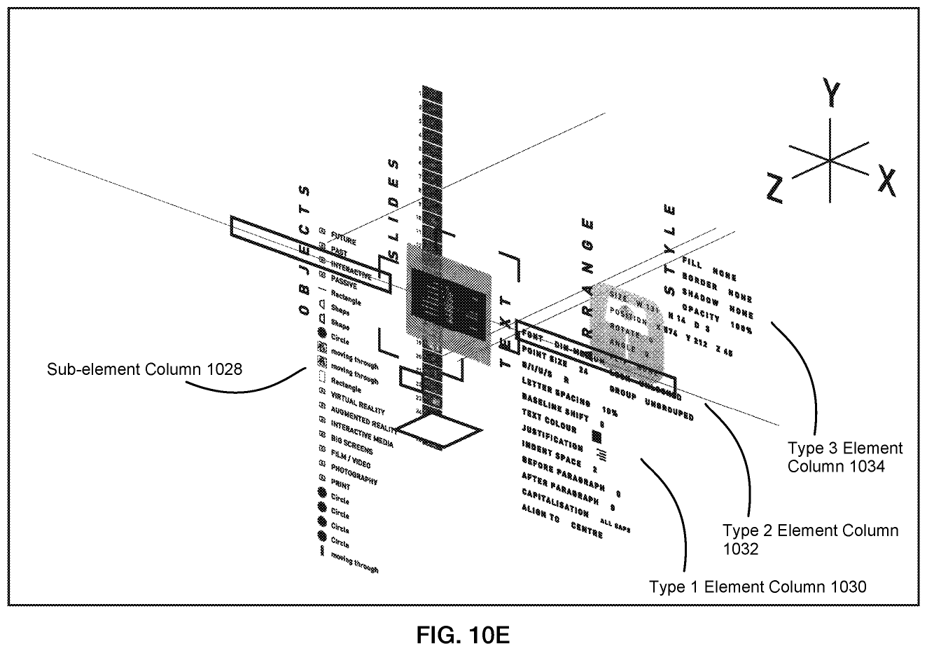

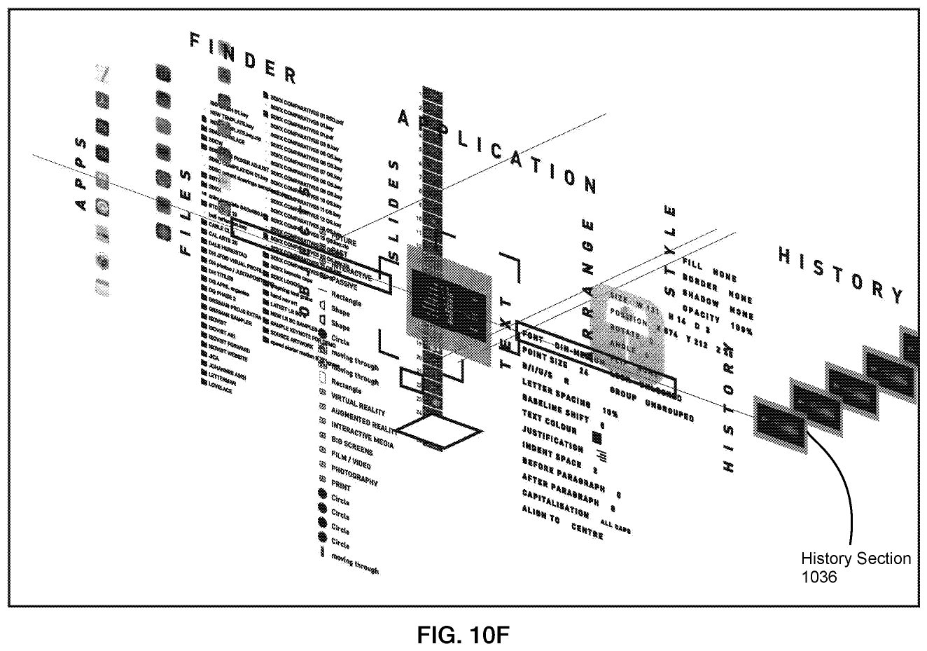

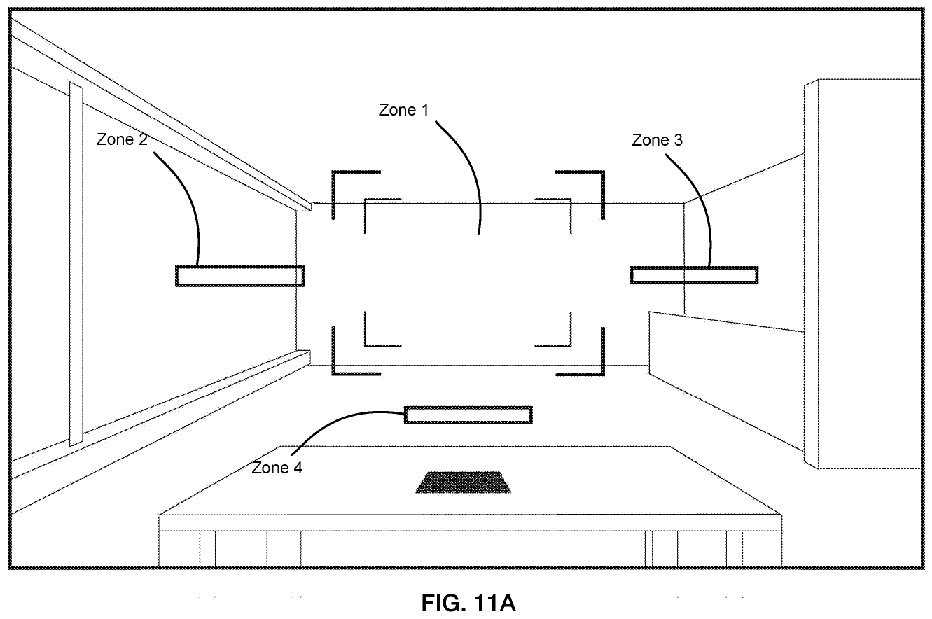

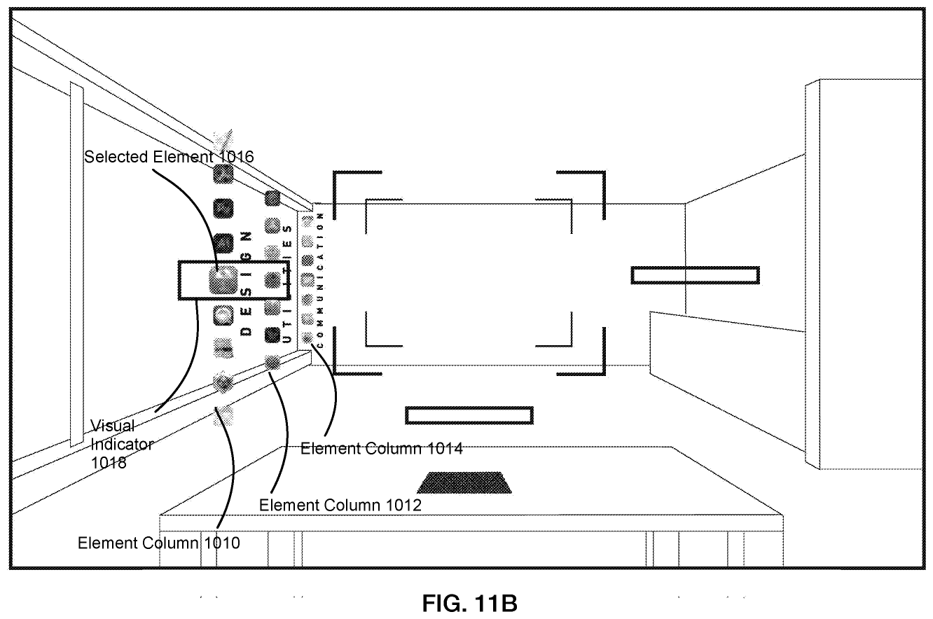

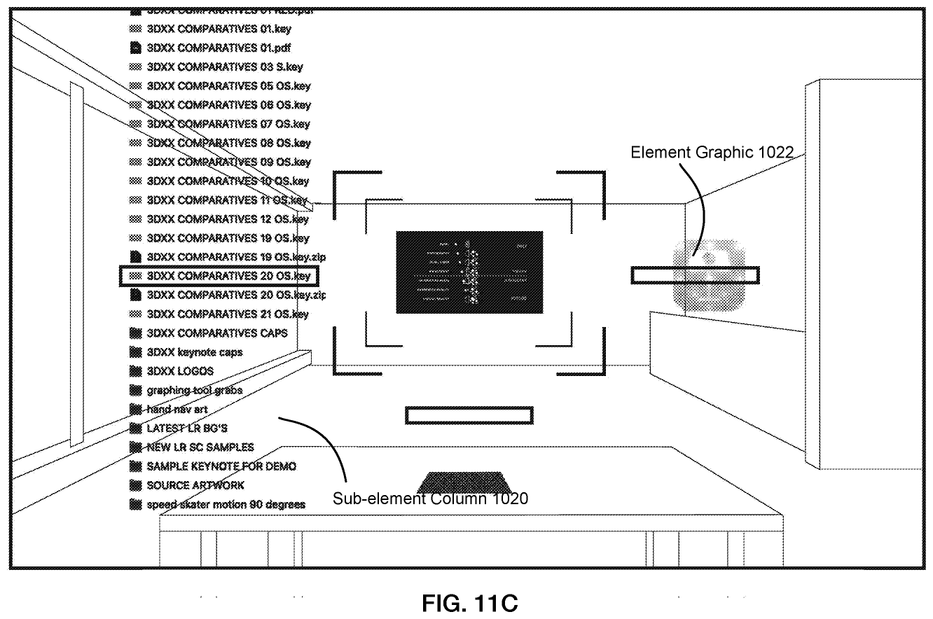

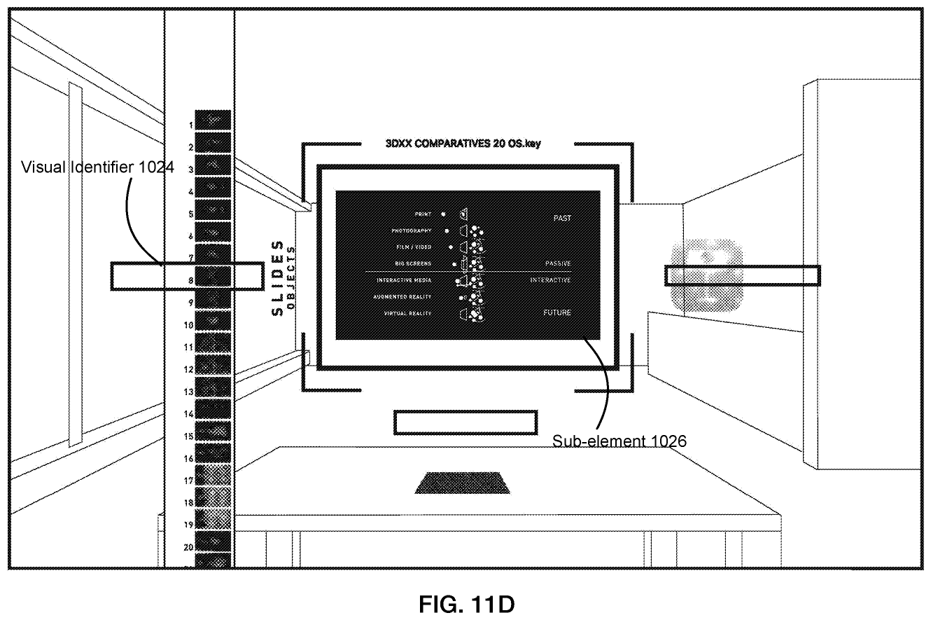

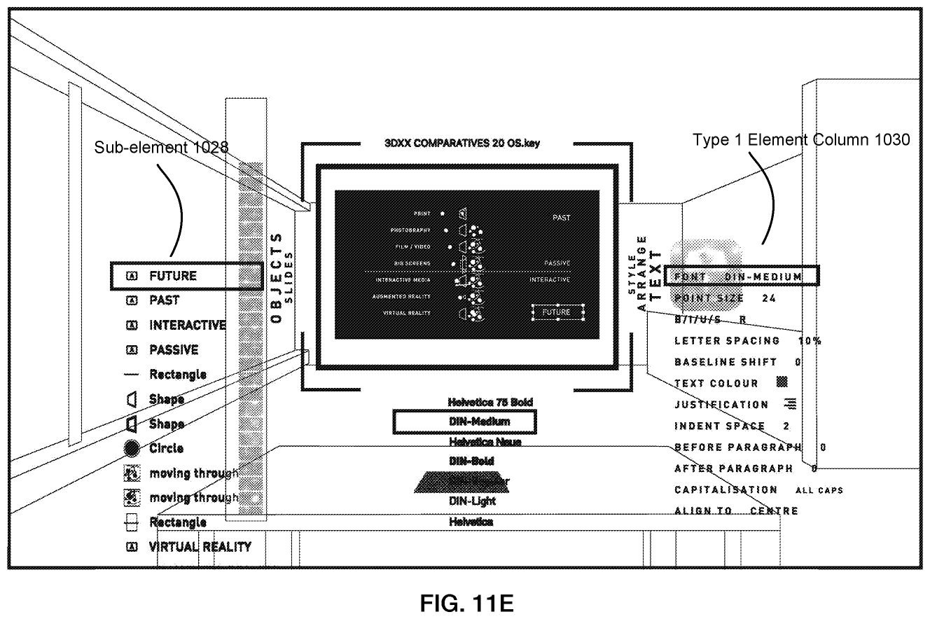

FIGS. 10A-10F illustrate isometric views of navigating an operating system using the exemplary user interface of the XR UI module 101. FIGS. 11A-11E illustrate user perspective views corresponding to the isometric views shown in FIGS. 10A-10E.

FIG. 10A depicts the isometric structure of zone user interface 1000, which includes zones 1, 2, 3, and 4. Axes 1001 depicts an XYZ-coordinate system in which the X-axis corresponds to left/right, the Y-axis corresponds to up/down, and the Z-axis corresponds to depth as in in/out. FIG. 11A depicts the user perspective of zone user interface 1000, which includes zones 1, 2, 3, and 4.

FIG. 10B depicts the isometric structure of zone user interface 1000 as the user navigates through a start up menu of an operating system. For example, the user might swipe left to right (from zone 2 to zone 3), and zone user interface 1000 presents a plurality of software applications to select from. This list is provided in zone 2 and is divided into multiple columns, namely, element column 1010, element column 1012, and element column 1014. In some aspects, the columns may represent an organisation system in which each column holds a specific type of element (e.g., communications elements, utility elements, design elements, etc.). The user may select an application (e.g., a slider editor) by scrolling through element column 1010 until the desired application (i.e., selected element 1016) is placed in visual indicator 1018. Swiping left to right opens the selected application in visual indicator 1018. FIG. 11B depicts the user perspective of the list of applications and selected element 1016.

FIG. 10C depicts the isometric structure of zone user interface 1000 as the user navigates through menus of an application. Once an app is opened, FIG. 10C shows the hierarchical display of files relating to the application that has been opened. They may, as in this case, begin at the front of the depth axis array with project folders, and after placing desired job folder in the selection rectangle, the columns move forward (or are pulled forward using a two finger downward swipe), and the respective column of files is in place to navigate up/down to a desired file.

Suppose that the user launches the application associated with selected element 1016. To make the selection, in an exemplary aspect, the user touches zone 2 (e.g., with selected element 1016 in visual indicator 1018) and swipes to the right. In some aspects, a logo/icon associated with the launched application may be set as element graphic 1022. Element graphic 1022 is positioned in the background of zone 3. In an exemplary aspect, the first menu associated with the launched application is presented in zone 2. For example, the slide editor may request the user to select a file to launch. Again, zone 2 displays a list of files arranged in sub-element column 1019 and sub-element column 1020. FIG. 11C depicts the user perspective of the list of files and element graphic 1022.

FIG. 10D depicts the isometric structure of zone user interface 1000 as the user makes selections in the application. Suppose that the user selects a file in the list of files shown in FIG. 10C. Zone user interface 1000 may change zone 2 to provide a list of contents in the file. Primary zone 1 may output on of the contents in the list. For example, a user may select one of the slides (i.e., sub-element 1026) in the selected file by scrolling through the list of contents until the desired file is highlighted by visual identifier 1024. The full view of sub-element 1026 may be displayed in primary zone 1. FIG. 11D depicts the user perspective of the list of contents and sub-element 1026. More specifically, FIG. 10D depicts a unique set of options specific to a slider editor, namely “objects” and “slides.” It should be noted that other apps will have different options in zone 2. Once the user selects a slide to edit, the user will see the “objects” list of the specific elements in that slide in order of front to back. Pressing and holding on zone 2 in the “objects” column presents a selection of types of “objects” from which user chooses to create a new object.

FIG. 10E depicts the isometric structure of zone user interface 1000 as the user makes further selections in the application. The example shown in FIG. 10E is similar to the example shown in FIG. 6, in which objects in primary zone 1 are selected using zone 2, the attribute of the object to edit is selected using zone 3, and the attribute is edited using zone 4. FIG. 10E further depicts the various columns associated with the attributes. For example, the object selection is organized in sub-element column 1028. The attribute types are organized as type 1 element column 1030 (associated with text), type 2 element column 1032 (associated with arrangement), and type 3 element column 1034 (associated with style). A user may toggle between each column in zone 3 using motion 914 shown in FIG. 9B. FIG. 11E depicts the user perspective of the isometric view in FIG. 10E. Like the left-side columns in zone 2, the right-side columns in zone 3 are specific to the slide editor. Other applications will have other options. The slider editor in the given example organizes object editing in 3 types: TEXT (for working with text), ARRANGE (for grouping, positioning, sizing, etc.), and STYLE (for addressing opacity, borders, etc.).

FIG. 10F depicts the isometric structure of zone user interface 1000 that includes history section 1036. Whenever a user interacts with zone user interface 1000, a snapshot of the view that results from the user interface is saved as a historical view. These snapshots are accessible via history section 1036, which enables a user to select any particular snapshot and return to that setup/view with minimal latency. It should be noted that the user does not see the finder on the left, or the history on the right from the user's perspective. The view in FIG. 10F simply provides awareness of where they are located and affect how the user gestures to access them.

FIGS. 12A-12F illustrate an example of navigation through another software application executed in an extended reality setting using the XR UI module 101. For example, another software application may be a spatial 3D XR software for group presentation and adjustments of architectural spaces. It is an example of how an interior design firm can present a client or team member (in same room or remotely) a design for, in this case, a floor in a high-rise building. A presenter would have access to the application and control what is viewed, and also make alterations to the design in real time.

Following the zone structure described in FIG. 10A, FIG. 12A depicts an output view 1204 of a building in primary zone 1. Zone 2 includes multiple columns, namely, floors, rooms, and surfaces. Zone 3 too includes multiple columns, namely, details, lighting, and décor. It should be noted that the columns in zone 3 are empty until a selection is made in zone 2. For example, the user may scroll through the list of floors until the visual identifier encompasses selection 1202 (e.g., floor 1) of the building. In response, output view 1204 depicts floor 1 as highlighted. Suppose that the user scrolls downwards in zone 2 until the visual identifier encompasses selection 1206 instead (e.g., ground). In response, output view 1208 depicts the lobby on the ground as highlighted. This is shown in FIG. 12B.

In some aspects, the user may select a floor in primary zone 1 by selecting the floor from a list in zone 2. Suppose that the user selects the ground lobby by making a selection gesture (e.g., clicking/tapping/pointing on selection 1206 or swiping from left to right). This generates output view 1212 in FIG. 12C, which depicts an expanded view of the ground floor in primary zone 1 by which the user can view individual rooms in the selected floor. These rooms are also listed in zone 2 (e.g., reception, VIP lounge, lifts, etc.). In output view 1212, the reception area is highlighted by default because the “reception” is the default selection in zone 2 (i.e., selection 1210).

In another example, the user can select a different room (e.g., VIP lounge) in the selector on the left, by scrolling down the rooms in FIG. 12C and, when VIP lounge is in the visual indicator (selection 1214), swiping left to right to “open” options related to the VIP lounge. In response, the VIP lounge area is highlighted in output view 1216. This is shown in FIG. 12D.

The user selection of rooms in FIG. 12D may be a very small room in a cluster of other small rooms (as in the upper back of the depicted floor model). Navigating a list of rooms on the left is more efficient for selection than trying to select within the model.

Suppose that the user selects selection 1214 (e.g., makes a tapping/swiping gesture). In response, the view shown in FIG. 12E is generated. In these cases, the object in zone 1 zooms forward to be in a zoomed showcase position. This zooming in and out avoids the potential disruptive nature of simply appearing in the zoomed up position and offers fluidity. More specifically, zone 2 lists the various selectable surfaces in the VIP lounge and primary zone 1 provides an expanded view of the VIP lounge. When the user selects selection 1218 (e.g., the floor), the details column in zone 3 is populated. The details column includes various editable attributes of the selected surface. For example, the user may edit the size of the floor. Suppose that the user selects selection 1222 (e.g., the size). In response, zone 4 is populated, which depicts the boundaries of the floor. A selection 1224 in zone 4 may ultimately change the boundaries or shape of the selected floor surface. In some aspects, the user may return to the selection of a room (i.e., the view in FIG. 12D) by swiping right to left to “close” the options related to the VIP to select another room.

FIG. 12F illustrates how a user may interact with an element in zone 1, which affects how elements in zones 2, 3, and 4 are displayed. For example, a user may rotate the floor plan shown in zone 1 (e.g., by making motion 932). Accordingly, the element corresponding to the floor plan outline in zone 4 is rotated to match the rotation in zone 1. Similarly, the elements corresponding to the “surfaces” column are rotated to match the rotation in zone 1. This enables the user to clearly see which visual elements to select. If the elements in zone 2 and 4 remain static, the user may not be able to discern which surfaces to select in zone 1 as, depending on the rotation, some parts of the element in zone 1 may be get hidden or obscured (thus, the element as shown in zone 2 may not be detected by the user). In some aspects, the interaction shown in FIG. 12F works as follows: (1) a user presses and holds on zone 4, which causes the element in the zone to expand in size with number dimension label appearing above the edges, (2) the user moves his/her finger in the direction of the location of the edge of the floor they wish to alter to confirm visually on zone 1 that they have selected the correct edge, (3) the edge moves in real time and the data display of measurement changes in real time.

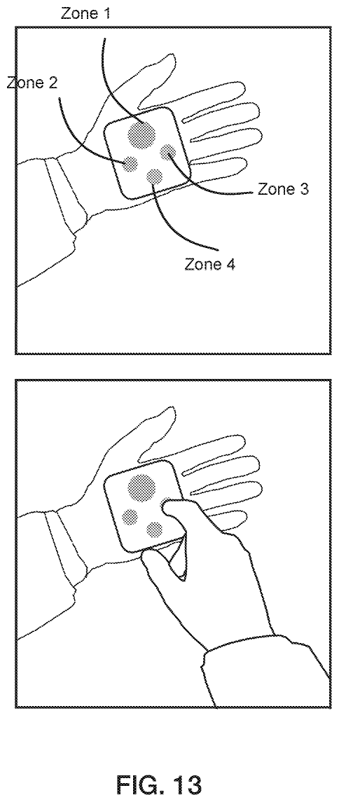

FIG. 13 illustrates mapping, as performed by XR UI module 101, of the input-receiving elements of the user interface on a palm surface. The gestures mentioned in the present disclosure resemble gestures that can be performed on a touch screen or mouse pad (e.g., tapping, clicking, scrolling, etc.). As mentioned previously, when the depth property is introduced in an extended reality setting, the complexity of user interaction becomes increasingly complex. Although science fiction media often depicts interactions involving pointing, pinching, and dragging objects arranged along varying depths, these interactions do not translate well in real world applications. For example, if a person points at a block in a cubic structure shown in FIG. 5, there is a high likelihood that due to the busy nature of the visual (closely arranged small blocks), the desired block will not be selected. In fact, the system will likely be unable to determine the level of depth the desired block is located in. The zone user interface improves the navigation through a busy visual (such as the cubic structure, the slide editor, the 3D modeling software, etc.), but this navigation is made more robust by mapping the zones onto a surface. In FIG. 13, the virtual zones of zone user interface are mapped to physical zones on a palm of the user. It should be noted that the circular areas shown in FIG. 13 are only demonstrative are not actually projected or drawn on the hand. They are discerned by software from a finger of one hand touching a specific area of the palm of the other hand.

The user may then perform gestures on the physical zones as though the surface is a touchscreen. For example, in FIG. 13, the user points and performs a gesture in a physical zone corresponding to zone 3. In some aspects, the mapping and gesture identification may be performed by a camera that is located in the environment where the user is located. In some aspects, the mapping and gesture identification may be performed by an on-board camera of extended reality device 100 and/or computing device 200. In some aspects, the size of each physical zone is proportional to the size of each virtual zone.

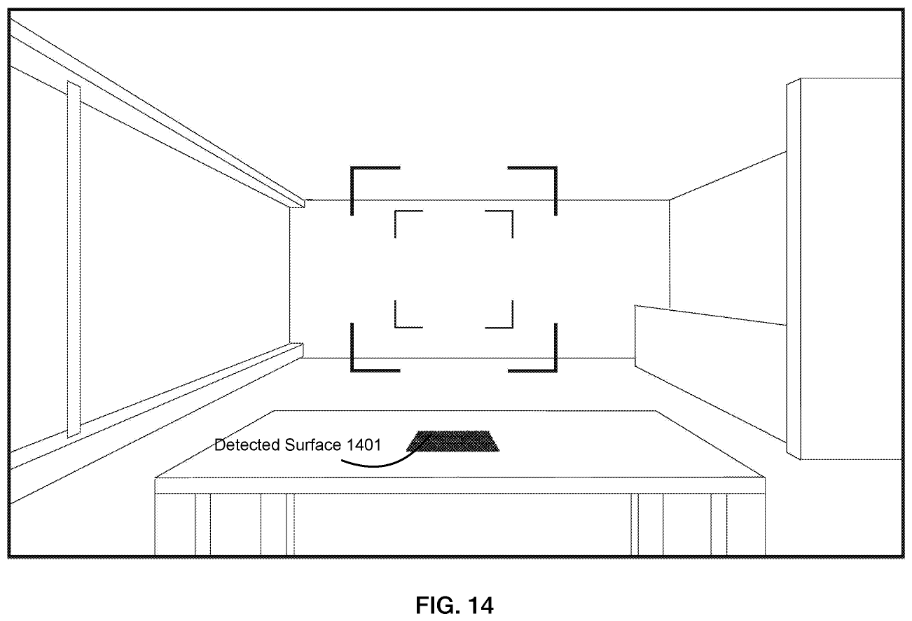

FIG. 14 illustrates mapping, as performed by XR UI module 101, of the input-receiving elements of the user interface on a hard surface. Mapping specifically refers to assigning one virtual zone to a physical zone (e.g., noting a correspondence between the two and storing the correspondence in memory). In an exemplary aspect, the surface on which the physical zones are identified may be a physical surface in the physical environment. For example, FIG. 14 depicts the view of the user while wearing extended reality device 100. The physical environment of the user includes detected surface 1401 (e.g., a paper) onto which the virtual zones are mappable. In some aspects, detected surface 1401 may be identified using a camera. There are two aspects to consider regarding the navigation surface: (1) 1 the rectangular area (e.g., physical area or touch area) of interaction defined, and (2) the zones that relate to this rectangular area.

In some aspects, detected surface 1401 may be a touch screen of a smartphone/tablet. The inputs may be received by the touch screen and transmitted to the extended reality device 100. It should be noted that the display of the tablet/smartphone may be off so long as the touch inputs can still be received and transmitted.

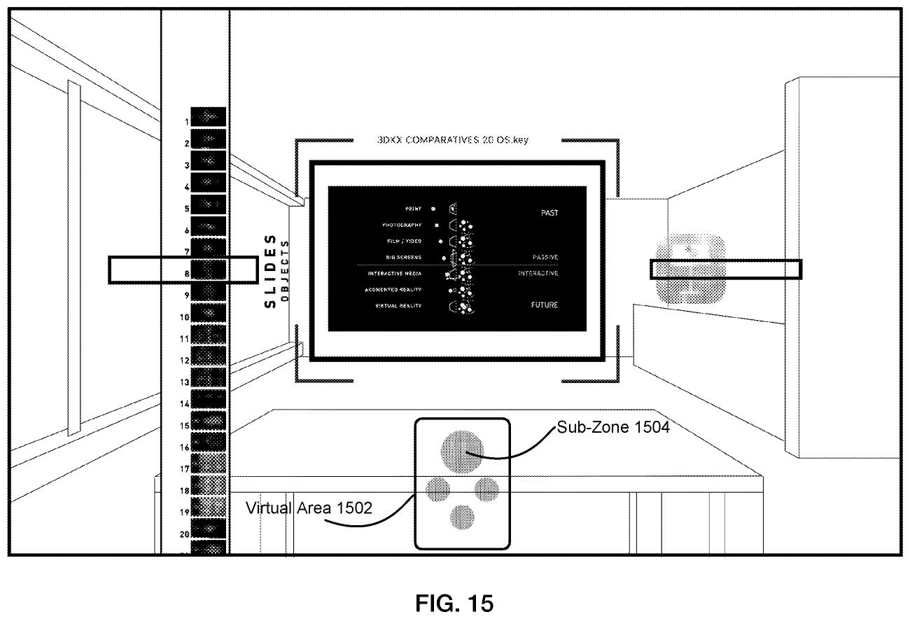

FIG. 15 illustrates mapping, as performed by XR UI module 101, of the input-receiving elements of the user interface on a virtual area. In some aspects, the virtual zones may be presented on a virtual area 1502. For example, virtual area may be a transparent boundary (e.g., a rectangle) in which each zone on the zone user interface is mapped to a sub-zone of the virtual area. The user may interact with the sub-zone, which may translate to a command executed on the corresponding zone. For example, when the user makes a gesture in sub-zone 1504, a corresponding action is performed in zone 1. Because the virtual surface is not bound to any physical object in the environment, the user may place or relocate the virtual surface where he/she wishes. Ideally, however, if placed just below the interaction space (i.e., the display of zones 1,2,3,4) the user may see the virtual surface in their peripheral vision, which aids in placing their finger in the correct zones for navigation. Additionally, the user may use a gesture, such as a hand grab gesture, to “select” the virtual surface and move the surface to another position. In an example of a complex three-dimensional game, a user may be able to directly grab the vertical arrays in zones 2 and 3, grab the main game object in zone 1, and with the help of interaction proxies at the bottom, navigate the zonal displays directly (e.g., using pinch as an example of selection).

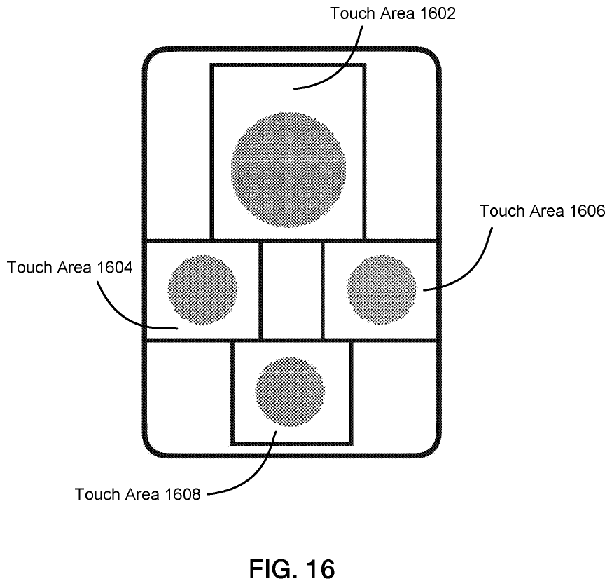

As shown in FIG. 16, XR UI module 101 identifies touch areas (interchangeable with physical zones) 1602, 1604, 1606, and 1608 on detected surface 1401. Each physical zone corresponds to a virtual zone in a similar placement. For example, touch area 1602 is mapped to primary zone 1, touch area 1604 is mapped to zone 2, touch area 1606 is mapped to zone 3, and touch area 1608 is mapped to zone 4. When a gesture is detected in touch area 1604, for example, the command associated with the gesture is executed in zone 2. Suppose that the user performs motion 902 in touch area 1602. In response to identifying the motion (e.g., via a camera) and the corresponding virtual zone (i.e., zone 2), XR UI module 101 executes the command in zone 2.

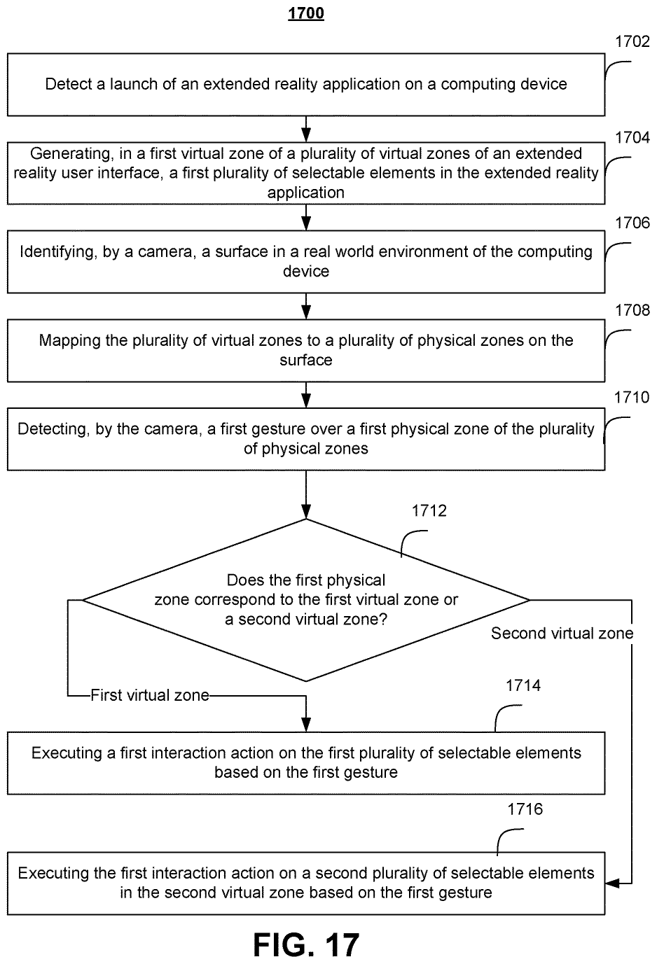

FIG. 17 illustrates a flow diagram of a method 1700 for generating and enabling interaction with an extended reality device. At 1702, XR UI module 101 detects a launch of an extended reality application (e.g., a slide editor, a game, a 3D modeling software, etc.) on a computing device (e.g., computing device 200, extended reality device 100.

At 1704, XR UI module 101 generates, in a first virtual zone (e.g., zone 2) of a plurality of virtual zones (e.g., primary zone 1, zone 2, zone 3, zone 4) of an extended reality user interface (used interchangeably with zone user interface), a first plurality of selectable elements in the extended reality application. For example, referring to FIG. 10D, the first plurality of selectable elements may be a list of slides in a selected slide deck. Each element may be a thumbnail that represents a slide in the list.

At 1706, XR UI module 101 identifies (e.g., by sensor(s) 104, sensor(s) 202, etc.) a surface in a real world environment of the computing device. In some aspects, the surface is one of: a hand of a user (e.g., as shown in FIG. 13) and a flat surface in front of the user (e.g., as shown in FIG. 14), in which case the surface is identified by a camera. In some aspects, the surface is a touchscreen, a track pad on a game controller/remote device, etc., in which case, the surface is identified based on receipt of a user input on said surface. In this case, there is a distinct difference between a touchscreen surface on a device that also displays the XR application and graphics and a peripheral device that solely receives use input (e.g., a wirelessly connect smartphone whose touchscreen is used despite the display of the smartphone being off and not displaying anything).

Suppose that the surface is identified using a camera. For example, XR UI module 101 may identify detected surface 1401. In some aspects, when identifying a surface, XR UI module 101 may look for preprogrammed surfaces such as the palm of a user, a piece of blank paper, an empty table, etc., using image classification techniques. In some aspects, XR UI module 101 may determine that the classified surface is a candidate for mapping virtual zones in response to determining that a size of the detected surface meets a predetermined size and shape requirements. For example, a predetermined size and shape requirement may be that the shape needs to be a square or rectangle with at least 5 inches in width and 5 inches in height. XR UI module 101 may receive one or more image frames from a camera of the extended reality device 100 and may search for surfaces within reach of the user's arms (e.g., in the lower third pixels of the received image frames) that are classified as a preprogrammed object (e.g., a paper, a folder, a table, etc.) and meet the size and shape requirements of a candidate surface. In response to detecting surface 1401, for example, XR UI module 101 may determine that surface 1401 is a paper that meets the predetermined size and shape requirements.

In some aspects, XR UI module 101 may detect a physical object (e.g., a paper) that comprises the surface in the real world environment. XR UI module 101 may generate, on the extended reality user interface, a virtual object that visually corresponds to the physical object. For example, XR UI module 101 may generate a virtual paper that appears like the real world physical paper. XR UI module 101 may then generate a visual of the first gesture on the virtual object. This enables a user to reference their gestures on the virtual object if needed.

In some aspects, XR UI module 101 may receive a request to change the surface. For example, XR UI module 101 may detect a paper on a table in front of the user, but the user may not prefer using that paper as a trackpad. In some aspects, the request may include an explicit selection of another surface. For example, the user may select his/her palm to be the surface. In response to receiving the request, XR UI module 101 identifies, by the camera, another surface in the real world environment (e.g., the palm) and maps the plurality of virtual zones to a plurality of physical zones on the another surface. Accordingly, the user has flexibility to change surfaces. In some aspects, a user may be interacting with an extended reality application and midway may decide to change the surface on which the interaction is performed. For example, the user may be wearing an extended reality device 100 and sitting in front of a desk. Initially, the physical zones may be identified on the table. Suppose that while interacting with the extended reality application, the user gets up and begins walking. XR UI module 101 may detect that the surface (e.g., the table) is no longer accessible, and may identify the user's palm as the surface onto which the physical zones should be identified.

At 1708, XR UI module 101 maps the plurality of virtual zones to a plurality of physical zones on the surface. For example, the extended reality user interface may include primary zone 1, zones 2, zone 3, and zone 4. XR UI module 101 may virtually mark physical zones (e.g., touch areas 1602, 1604, 1606, and 1608) on detected surface 1401 as shown in FIG. 14. XR UI module 101 may then map each virtual zone with a physical zone. For example, XR UI module 101 maps touch area 1602 to primary zone 1, maps touch area 1604 to zone 2, maps touch area 1606 to zone 3, and maps touch area 1608 to zone 4. On a technical level, mapping may involve storing, in a relations database, an indication that touch area 1602, for example, has a certain dimension and position in the extended reality setting, which directly relate to zone 1.

At 1710, XR UI module 101 detects a first gesture over a first physical zone of the plurality of physical zones. Again, this detection may be performed using a camera or the touchscreen of a peripheral device connected to the computing device outputting the XR application. For example, XR UI module 101 may receive a plurality of consecutive image frames from the camera that show a pointer finger of the user moving in a motion resembling motion 902. In particular, the pointer finger may be touching or hovering over a particular physical zone during the first gesture. It should be noted that although XR UI module 101 identifies the pointer finger as the object to track in this example, XR UI module 101 may be programmed to track any other object such as a stylus, a handle, multiple fingers, a pen, a pencil, and arm, etc.

At 1712, XR UI module 101 determines whether the first physical zone corresponds to the first virtual zone (e.g., zone 2) or a second virtual zone (e.g., zone 3). In response to determining that the first physical zone corresponds to the first virtual zone, method 1700 advances to 1714, where XR UI module 101 executes a first interaction action on the first plurality of selectable elements based on the first gesture. In response to determining that the first physical zone corresponds to the second virtual zone, method 1700 advances to 1716, where XR UI module 101 executes the first interaction action on a second plurality of selectable elements in the second virtual zone based on the first gesture.

In general, when a gesture is detected in a physical zone such as physical zone 12, the interaction action associated with the gesture is executed in the corresponding virtual zone. Suppose that the user performs a gesture corresponding to motion 902 in physical zone 12. In response to identifying the motion (e.g., via a camera) and the corresponding virtual zone (e.g., zone 2), XR UI module 101 executes the action(s) associated with the motion in zone 2.

In some aspects, the first gesture is associated with a selection. For example, the user may make a pointing gesture (e.g., pointing a finger at a location in the physical zone and retracting the finger immediately after). In this case, when executing the first interaction action, XR UI module 101 selects a first element (e.g., selected element 1016) from the first plurality of selectable elements (e.g., organized as element columns 1010, 1012, and 1014). More specifically, a virtual location of the first element in the first virtual zone corresponds to a physical location last touched in the first physical zone during the first gesture (e.g., the location of the finger before retraction). Based on this gesture, the first interaction action involves generating an output view associated with the first element in a primary virtual zone of the plurality of virtual zones. For example, if the selected element is a slide thumbnail as shown in FIG. 10D, sub-element 1026 is generated for view in primary zone 1.

In some aspects, the first gesture is associated with a vertical scroll with a single finger (e.g., motion 902). In this case, when executing the first interaction action, XR UI module 101 slides the plurality of selectable elements along a vertical axis until a desired selectable element enters a fixed indicator (e.g., visual identifier 1024). The direction of the sliding corresponds to a direction of the first gesture on the surface. For example, the user may slide his/her finger in an upward direction in the first virtual zone. In response, XR UI module 101 may move the list of slides shown in FIG. 10D upward. The amount of virtual displacement of the elements is proportional to the distance that the finger moves in the physical zone. When the user ends the gesture (e.g., by retracting his/her finger), the element within visual identifier 1024 is considered the selection.

In some aspects, the first gesture is associated with a vertical scroll with two fingers. Suppose that the first plurality of selectable elements is organized in more than one column (e.g., sub-element column 1019 and sub-element column 1020). When executing the first interaction action, XR UI module 101 slides across the more than one column arranged along a depth axis. Here, the direction of the sliding is based on a direction of the first gesture on the surface. This gesture may correspond to motion 912 shown in FIG. 9B.

It should be noted that after detecting the first gesture, XR UI module 101 may detect, by the camera, a second gesture over a second physical zone of the plurality of physical zones. Suppose that the second virtual zone (e.g., zone 3) of the plurality of virtual zones outputs a second plurality of selectable elements (e.g., shown in type 1 element column 1030, type 2 element column 1032, and type 3 element column 1034). In response to determining that the second physical zone corresponds to the second virtual zone of the plurality of virtual zones, XR UI module 101 executes another interaction action on the second plurality of selectable elements based on the second gesture. For example, the second gesture may correspond to motion 914 and the another interaction action may involve scrolling through and selecting one of the element columns 1030, 1032, and 1034.

In some aspects, the techniques for generating and enabling interaction with the extended reality user interface described herein—including the zone-based navigation architecture, the mapping of virtual zones to user input zones, and the detection and classification of gestures for executing interaction actions—may be performed using a wearable device worn by the user rather than using a camera-based detection system or a touchscreen of a peripheral device.

For example, rather than identifying a surface in the real world environment (e.g., detected surface 1401, a palm of the user, or virtual area 1502) and mapping the plurality of virtual zones to physical zones on said surface, XR UI module 101 may receive gesture data from a wearable device that identifies both a target zone and a gesture type based on sensor data captured directly from the user's body. In this approach, the wearable device replaces the camera and/or touchscreen as the primary input mechanism, and the gestures described in connection with FIGS. 9A-9E, 10A-10F, 11A-11E, 12A-12F, 13, 14, 15, and 16—including motions 902, 904, 906, 912, 914, 922, 924, and 932—may be executed and detected without the use of a camera, a touchscreen, or any physical or virtual surface onto which zones are mapped.

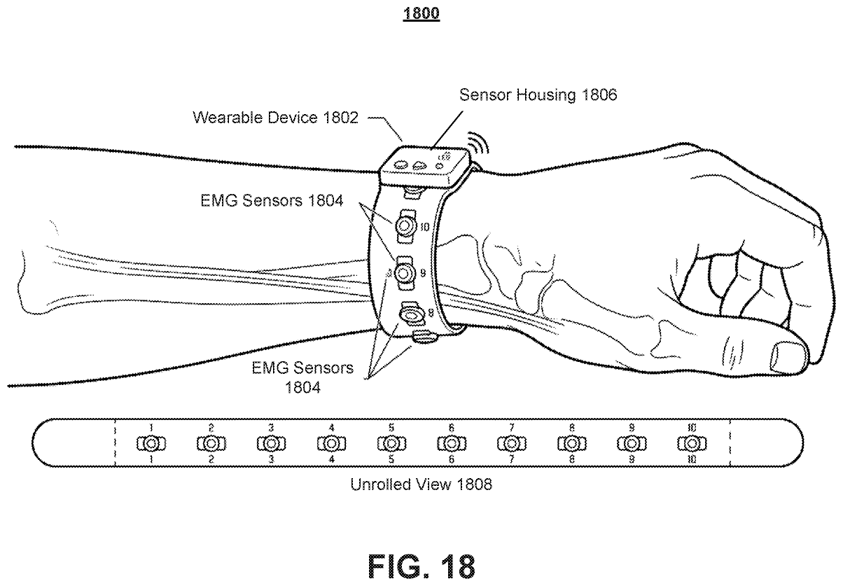

FIG. 18 is a diagram 1800 illustrating an example wearable device in the form of a wristband 1802 worn on a forearm of the user. In some aspects, wristband 1802 may comprise an array of electromyography (EMG) sensors 1804 positioned circumferentially around a volar and lateral portion of wristband 1802 in contact with skin overlying the forearm flexor musculature of the user.

FIG. 18 further depicts an unrolled view 1808 of wristband 1802, which illustrates that EMG sensors 1804 are distributed around the circumference of the wrist. Although a particular number and spacing of EMG sensors 1804 is shown in unrolled view 1808, the number of EMG sensors, the spacing between adjacent EMG sensors, and the arrangement of EMG sensors around the circumference of the wrist may vary and are not limited to the configuration depicted in FIG. 18.

EMG sensors 1804 may be configured to detect electrical signals generated by muscle contractions associated with individual finger movements of the user. It should be noted that EMG sensors 1804 are positioned on an inner surface of wristband 1802 so as to make direct contact with the skin of the wearer; however, EMG sensors 1804 are depicted in FIG. 18 on wristband 1802 as though they were on the outer surface for visual clarity and demonstration purposes.

As shown in FIG. 18, wristband 1802 may further comprise a sensor housing 1806 positioned on a dorsal portion of wristband 1802 (e.g., where a watch head would be placed on a conventional wristwatch). Sensor housing 1806 may include an inertial measurement unit (IMU) including a three-axis accelerometer and a three-axis gyroscope. The IMU may be oriented such that the sensing axes of the IMU are aligned with anatomical axes of the wrist joint, wherein a pitch axis corresponds to wrist flexion and extension, a roll axis corresponds to wrist pronation and supination, and a yaw axis corresponds to wrist radial and ulnar deviation.

Sensor housing 1806 may further include a processor configured to receive time-synchronized data streams from EMG sensors 1804 and the IMU and to classify, in real time, a gesture-zone pair based on the received data streams. In some aspects, the classification may be performed on a processor in the headset generating the user interface.

Sensor housing 1806 may further include a wireless communication component (e.g., a Bluetooth or Wi-Fi transceiver) configured to transmit a structured input event—comprising an identified zone and an identified gesture type—to extended reality device 100 and/or computing device 200.

Sensor housing 1806 may additionally include one or more of a display, a networking component, additional sensors (e.g., a heart rate sensor, a skin temperature sensor, or an ambient light sensor), a battery, and memory for storing classification models and user profiles. In this configuration, the extended reality device 100 and/or computing device 200 may execute the interaction action corresponding to the structured input event without performing any image processing or camera-based gesture recognition.

In some aspects, rather than mapping virtual zones to physical zones on a surface, XR UI module 101 may map each virtual zone to a distinct multi-finger pinch configuration detected by wristband 1802. Because each finger of the user's hand is controlled by a distinct set of muscles in the forearm, the co-activation of different combinations of fingers produces distinguishable electromyographic signatures that EMG sensors 1804 of wristband 1802 may detect. The processor within sensor housing 1806 may classify the number and identity of co-activated fingers to determine which virtual zone the user intends to interact with.

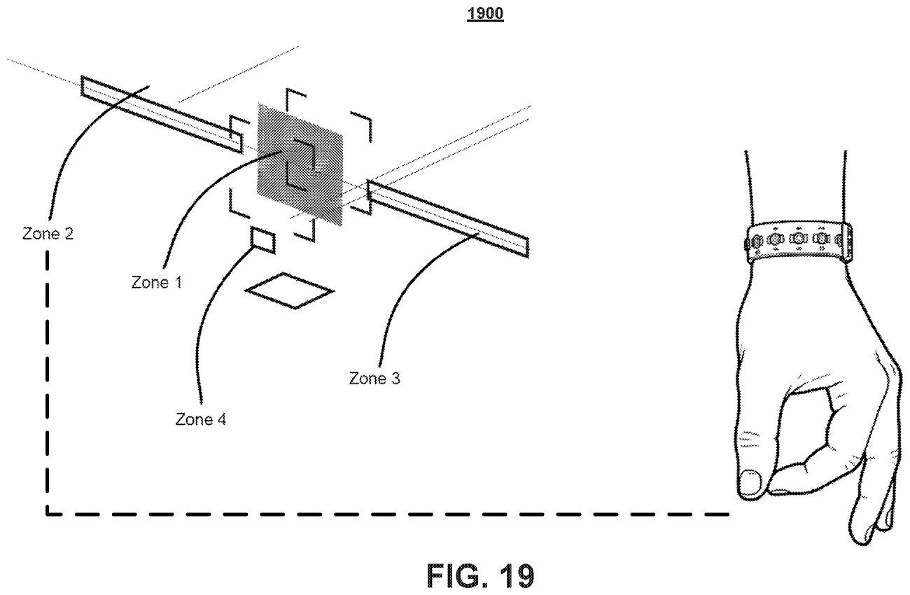

FIG. 19 depicts a two-finger pinch gesture in which the thumb and the index finger of the user are brought together in a pinch configuration. As shown in FIG. 19, the two-finger pinch is mapped to zone 2 (e.g., the left navigation zone), as indicated by a dashed line extending from the pinch gesture toward zone 2 in a basic layout depiction of the four-zone user interface. When EMG sensors 1804 detect co-activation of the flexor pollicis brevis (associated with the thumb) and the index compartment of the flexor digitorum superficialis (associated with the index finger), and no additional finger compartments exhibit co-activation above a classification threshold, the processor within sensor housing 1806 may classify the detected pinch configuration as a two-finger pinch corresponding to zone 2.

In some aspects, once a zone is identified based on the pinch configuration, the user may perform in-zone gestures while maintaining the pinch. The gestures may correspond to the motions described in connection with FIGS. 9A-9E.

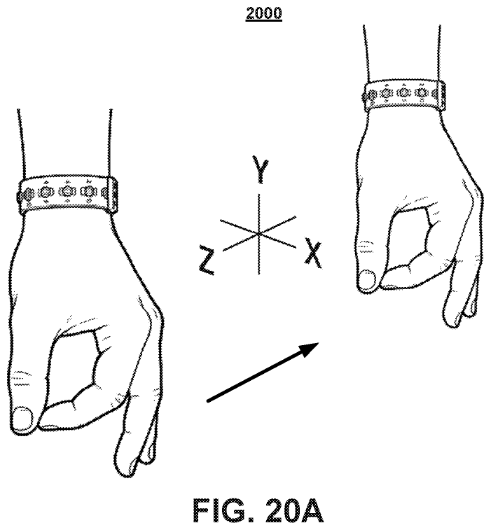

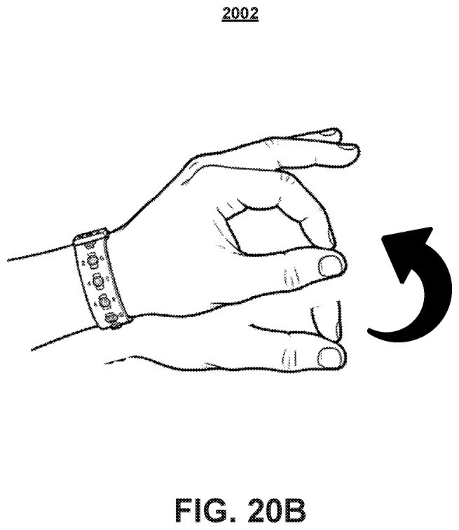

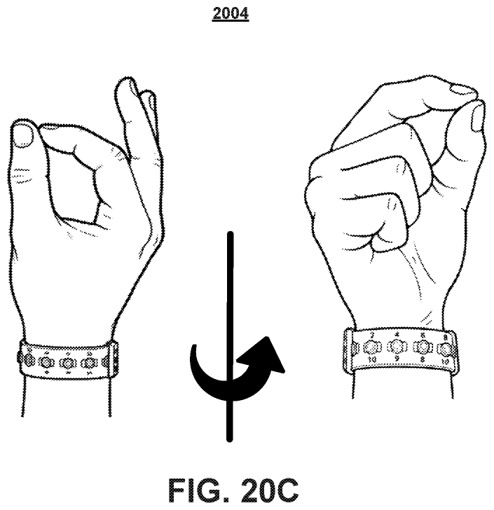

FIGS. 20A, 20B, and 20C illustrate example in-zone gestures performed while the user maintains the two-finger pinch configuration of FIG. 19 (corresponding to zone 2); however, the same gestures may be performed while maintaining any of the pinch configurations described herein, and the zone to which the gesture is applied may be determined by which pinch configuration is maintained during the gesture.

FIG. 20A depicts the hand of the user translating from a first position to a second position in three-dimensional space while maintaining the two-finger pinch configuration. The translation may occur along any axis or combination of axes in three-dimensional space (e.g., upward, downward, laterally, forward, or backward). The IMU within sensor housing 1806 may capture the translation by detecting linear acceleration along one or more axes via the accelerometer and angular displacement via the gyroscope.

The processor may determine the direction and magnitude of the translation based on the IMU data. In some aspects, a translation detected while a pinch is maintained may be mapped to a navigation action within the zone corresponding to the maintained pinch configuration. For example, a slow, sustained translation (e.g., linear acceleration below a first threshold magnitude sustained for more than a first threshold duration, such as 300 milliseconds) may be interpreted as a panning or browsing gesture within the zone, wherein the speed of panning corresponds proportionally to the velocity of the translation as measured by the IMU. The gesture may also be interpreted as dragging an item from on position to another.

A faster translation (e.g., linear acceleration exceeding a second threshold magnitude that is greater than the first threshold magnitude) may be interpreted as swipe gesture that initiates momentum-based scrolling within the zone. The processor may distinguish between a deliberate translation gesture and incidental hand drift by requiring that the linear acceleration exceed a minimum acceleration threshold before classifying the motion as an intentional gesture input.

FIG. 20B depicts the hand of the user performing an upward flick while maintaining the two-finger pinch configuration. The upward flick may be interpreted as a quick scroll upward within zone 2 (e.g., corresponding to motion 902 or motion 906 as described in connection with FIG. 9A). The IMU within sensor housing 1806 may detect the flick as a sharp angular velocity spike along the pitch axis (e.g., exceeding a flick threshold of 150 degrees per second) followed by a deceleration as the wrist comes to rest.

The processor may classify the gesture as a scroll-up gesture based on the direction of the angular velocity spike (positive pitch angular velocity corresponding to upward wrist flexion). The duration of the angular velocity spike may be short (e.g., less than 200 milliseconds), which distinguishes the flick from a slower, sustained wrist rotation that may instead be classified as a rotation gesture as described in connection with FIG. 20C. Similarly, a downward flick (e.g., a sharp negative pitch angular velocity spike) may be interpreted as a quick scroll downward within the zone. In response to detecting a scroll gesture, XR UI module 101 may slide the plurality of selectable elements in the corresponding virtual zone along a vertical axis in the direction of the flick, in a manner consistent with the scrolling behavior described in connection with FIG. 9A. The scroll distance or speed may be proportional to the peak angular velocity of the flick, such that a faster flick produces a longer or faster scroll.

FIG. 20C depicts the hand of the user rotating from a first orientation to a second orientation while maintaining the two-finger pinch configuration. The rotation may be interpreted as a rotation gesture within zone 2 (e.g., corresponding to motion 932 as described in connection with FIG. 9E). The IMU within sensor housing 1806 may detect the rotation as sustained angular velocity along the roll axis (wrist pronation/supination) or the yaw axis (wrist radial/ulnar deviation). Unlike the flick gesture of FIG. 20B, which produces a short, sharp angular velocity spike primarily along the pitch axis, the rotation gesture of FIG. 20C produces a more gradual and sustained angular velocity primarily along the roll axis or the yaw axis over a longer duration (e.g., greater than 300 milliseconds).

The processor may distinguish between a flick (FIG. 20B) and a rotation (FIG. 20C) based on which IMU axis exhibits the dominant angular velocity and based on the temporal profile of the angular velocity signal—a short spike along the pitch axis indicates a flick, whereas sustained angular velocity along the roll or yaw axis indicates a rotation. The processor may classify the gesture as a rotation gesture, and XR UI module 101 may rotate the element in the corresponding virtual zone in the direction and by the angular amount indicated by the angular displacement measured by the IMU.

In some aspects, to perform a selection within a selected zone (e.g., corresponding to a tap or pointing gesture), the user may release the pinch configuration and re-engage the same pinch configuration twice in rapid succession. EMG sensors 1804 may detect two temporally separated co-activation events within a defined time window (e.g., within 400 milliseconds), and the processor may classify the gesture as a double-tap selection gesture. Each co-activation event may have a duration of at least 30 milliseconds, and the release period between the two co-activation events may be at least 50 milliseconds, to distinguish the double-tap from a momentary signal fluctuation or an accidental loss of pinch contact. In response, XR UI module 101 may select the element currently within the fixed visual indicator of the corresponding virtual zone and may generate an output view associated with the selected element in primary zone 1, in a manner consistent with the selection behavior described in connection with FIGS. 10B-10D.

In some aspects, to explore depth within a selected zone (e.g., corresponding to navigating along a depth axis as described in connection with motion 912 or motion 914 in FIG. 9B), the user may maintain the pinch configuration associated with the selected zone and extend the arm forward or retract the arm backward. The accelerometer of the IMU within sensor housing 1806 may detect sustained positive linear acceleration along a forward axis (e.g., a z-axis) when the arm extends forward or sustained negative linear acceleration along the forward axis when the arm retracts backward.

The processor may distinguish a depth exploration gesture from the translation gesture depicted in FIG. 20A based on the axis of dominant motion and the temporal profile of the acceleration signal. For example, a depth exploration gesture may produce sustained linear acceleration primarily along the forward (z) axis with minimal lateral or vertical acceleration components, whereas the general translation of FIG. 20A may produce acceleration along any combination of axes. The processor may classify the gesture as a depth-forward or depth-backward gesture, respectively. In response, XR UI module 101 may traverse the columns arranged along the depth axis in the corresponding virtual zone, in a manner consistent with the depth navigation described in connection with shift 915 in FIG. 9B.

In some aspects, to navigate across applications or application histories (e.g., corresponding to motion 922 and motion 924 in FIGS. 9C and 9D), the user may maintain the pinch configuration associated with a zone and tilt the wrist laterally. The IMU within sensor housing 1806 may detect angular velocity along the yaw axis, and the processor may classify a leftward tilt as a navigate-back gesture and a rightward tilt as a navigate-forward gesture. In response, XR UI module 101 may execute the corresponding navigational action, such as going back to a previous menu of the application or going forward to another menu, in a manner consistent with the application navigation described in connection with FIGS. 9C and 9D.

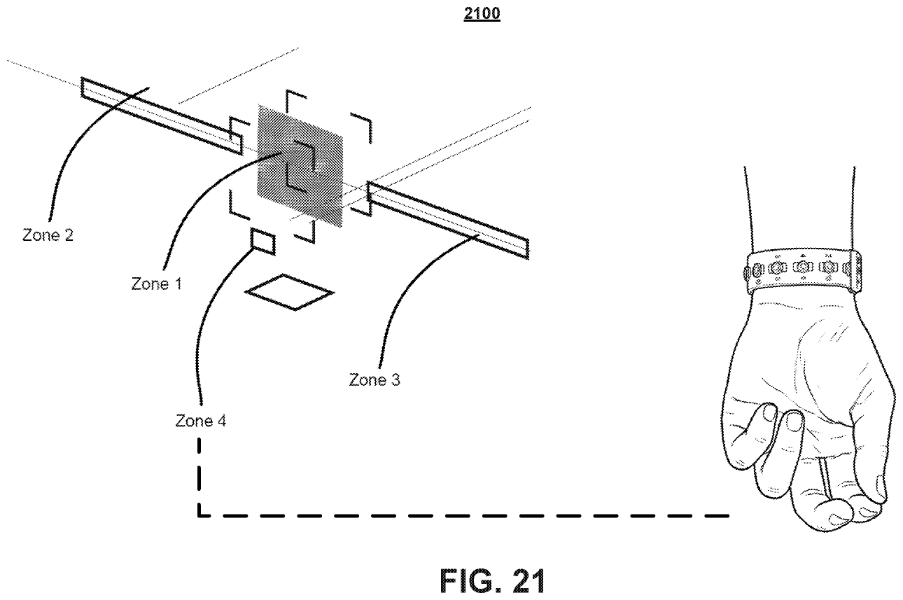

FIG. 21 depicts a three-finger pinch gesture in which the thumb, the index finger, and the middle finger of the user are brought together in a pinch configuration. As shown in FIG. 21, the three-finger pinch is mapped to zone 4 (e.g., the interaction proxies zone). When EMG sensors 1804 detect co-activation of the flexor pollicis brevis, the index compartment of the flexor digitorum superficialis, and the middle compartment of the flexor digitorum superficialis, and no additional finger compartments exhibit co-activation above the classification threshold, the processor within sensor housing 1806 may classify the detected pinch configuration as a three-finger pinch corresponding to zone 4.

Although not separately depicted, a four-finger pinch in which the thumb, the index finger, the middle finger, and the ring finger are co-activated may be mapped to zone 3 (e.g., the right navigation zone), and the processor may classify the four-finger pinch in a similar manner based on the additional co-activation of the ring compartment of the flexor digitorum superficialis.

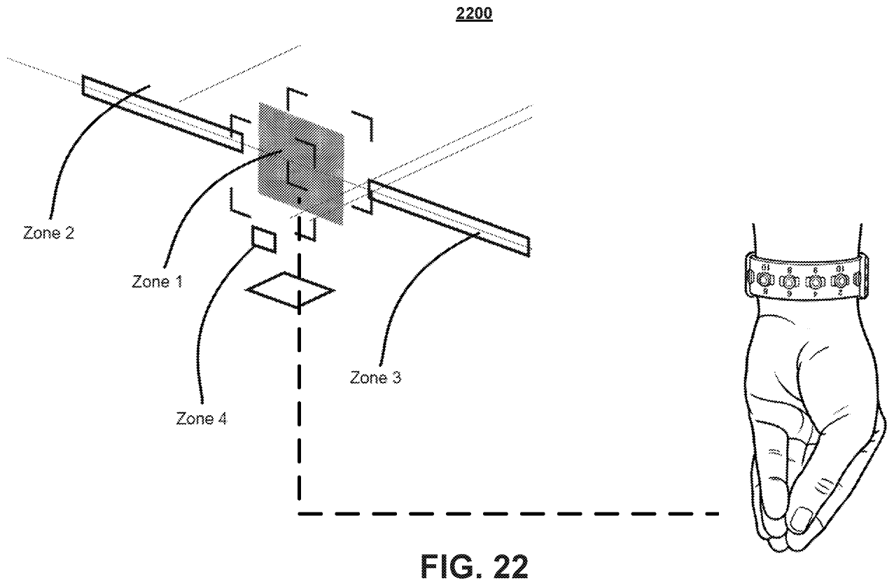

FIG. 22 depicts a full-hand pinch gesture in which the thumb and all four fingers (index, middle, ring, and little finger) of the user are brought together in a pinch configuration. As shown in FIG. 22, the full-hand pinch is mapped to primary zone 1. When EMG sensors 1804 detect co-activation across all forearm flexor compartments—including the flexor pollicis brevis and all compartments of the flexor digitorum superficialis—the processor within sensor housing 1806 may classify the detected pinch configuration as a full-hand pinch corresponding to primary zone 1.

In this manner, zone discrimination is achieved not by identifying a spatial position of a touch on a physical or virtual surface, but by identifying the number of co-activated fingers in a pinch configuration, wherein each progressively larger pinch configuration maps to a different virtual zone.

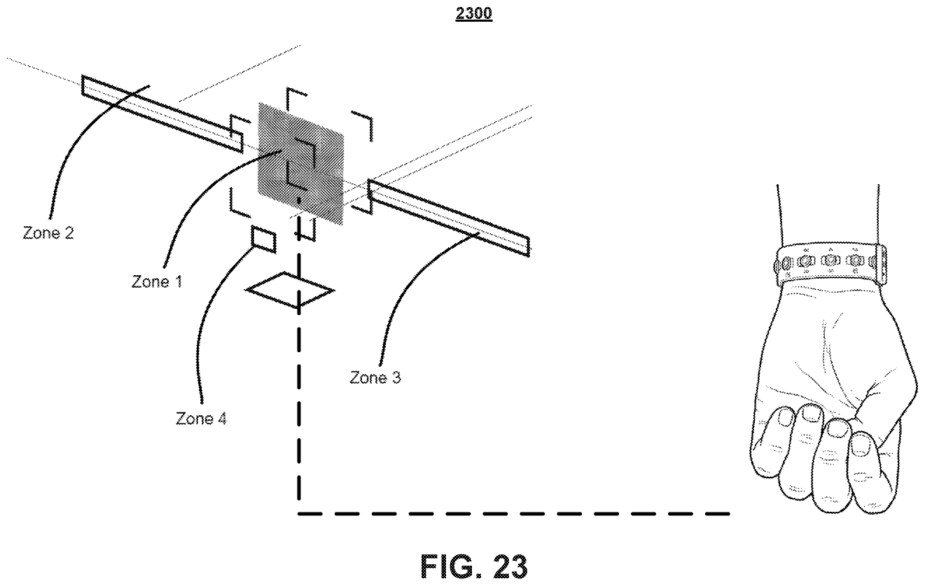

FIG. 23 depicts an alternative grip configuration in which the thumb of the user is tucked under four curled fingers, forming a fist-like grip. As shown in FIG. 23, the tuck configuration may serve as an alternative to the full-hand pinch depicted in FIG. 22 for selecting primary zone 1. The tuck configuration is also applicable as an alternative to all other pinch configurations described herein (e.g., the two-finger pinch of FIG. 19, the three-finger pinch of FIG. 21, and the four-finger pinch), such that the user may tuck the thumb under any number of curled fingers to select the corresponding zone.

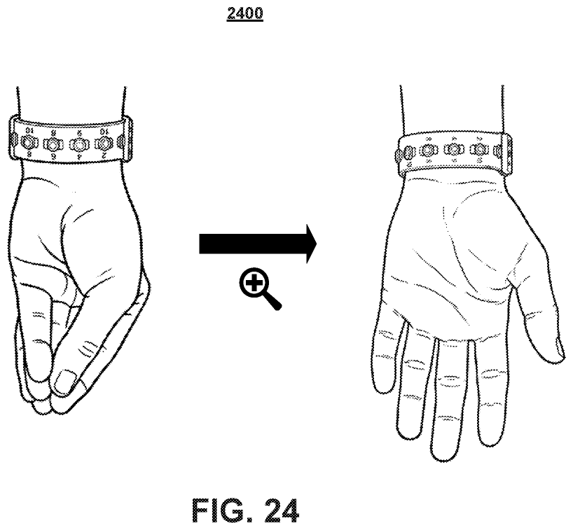

FIG. 24 depicts a zoom gesture in which the user transitions from the full-hand pinch configuration of FIG. 22 (corresponding to primary zone 1) to an open-hand configuration in which all fingers are extended and spread apart. The transition from the full-hand pinch to the open hand may be interpreted as a zoom-out gesture within primary zone 1. EMG sensors 1804 may detect the zoom-out gesture as a progressive decline in EMG amplitude across all forearm flexor compartments, beginning from the sustained co-activation state of the full-hand pinch and declining as the fingers extend and separate from the thumb. The processor may classify the gesture as a zoom-out gesture based on detecting that the EMG amplitude across all active compartments decreases below respective relaxation thresholds within a defined transition window (e.g., within 500 milliseconds), and that the decline occurs substantially simultaneously across all compartments rather than sequentially.

A sequential decline—in which one compartment deactivates significantly before the others (e.g., more than 100 milliseconds before a second compartment deactivates)—may instead be classified as a transition from a full-hand pinch to a smaller pinch configuration (e.g., transitioning from primary zone 1 to zone 3), rather than a zoom-out gesture. Conversely, a zoom-in gesture may be performed by transitioning from an open-hand configuration to the full-hand pinch configuration, and EMG sensors 1804 may detect the zoom-in gesture as a progressive increase in EMG amplitude across all forearm flexor compartments as the fingers close toward the thumb. The magnitude of the zoom may be proportional to the rate of EMG amplitude change during the transition—a rapid pinch-to-open transition may produce a larger zoom increment than a slow transition, enabling the user to control the zoom speed by controlling the speed at which the fingers extend or close. XR UI module 101 may apply the zoom-in or zoom-out action to the main focal element displayed in primary zone 1 in a manner consistent with the enlarge and shrink interactions described in connection with motion 932 and FIG. 9E.

In some aspects, zooming in and out may also involve a lateral movement along the depth axis while the user expands from a pinch gesture to an open hand gesture (i.e., slowly pulling the hand back while expanding the fingers may enlarge an object of interest in a given zone and slowly pushing the hand forward while returning to a pinch position may zoom out of said object).

In some aspects, the mapping between multi-finger pinch configurations and virtual zones may be configurable by the user. For example, XR UI module 101 may present a settings interface in which the user may assign any pinch configuration to any virtual zone. The co-activation gesture for selecting a zone may comprise a pinch configuration (e.g., as shown in FIGS. 19, 21, and 22), a tuck configuration (e.g., as shown in FIG. 23), or any other grip configuration that produces a detectable co-activation pattern in the corresponding number of forearm muscle compartments as measured by EMG sensors 1804.

In some aspects, the user may configure the number of fingers required for each zone. For example, a user may prefer to assign the two-finger pinch to primary zone 1 rather than zone 2. In some aspects, the user may configure the in-zone gestures as well. For example, a user may prefer a single-tap selection gesture rather than a double-tap selection gesture, or may prefer to assign the depth exploration gesture to wrist tilt rather than arm extension. In some aspects, XR UI module 101 may store the user's preferred gesture-zone mappings in a user profile and may load the preferred mappings when the user is identified (e.g., based on a login credential or a biometric identifier). In some aspects, the system may include a calibration routine in which the user performs each configured gesture while the processor records the corresponding EMG and IMU signatures and trains or updates the classification model based on the recorded data, thereby adapting the classifier to the user's individual muscle activation patterns and range of motion.

In some aspects, the processor within sensor housing 1806 may employ a classification algorithm to jointly infer a gesture-zone pair from the time-synchronized EMG and IMU data streams. The classification algorithm may be a machine-learning model such as a recurrent neural network, a hidden Markov model, a convolutional neural network, or a support vector machine trained on labeled gesture samples. The output of the classification algorithm may be a composite classification comprising an identified zone and an identified gesture type (e.g., “scroll up in zone 2” or “rotate in primary zone 1”), rather than independently classifying the zone and the gesture.

The joint inference may resolve ambiguities that either sensor modality would face in isolation. For example, the IMU alone may be unable to distinguish a scroll gesture performed during a two-finger pinch (e.g., as shown in FIG. 19) from a scroll gesture performed during a full-hand pinch (e.g., as shown in FIG. 22), because the wrist kinematics may be substantially identical in both cases. Similarly, EMG sensors 1804 alone may be unable to distinguish a scroll-up gesture (e.g., FIG. 20B) from a rotation gesture (e.g., FIG. 20C) performed with the same finger configuration, because the muscle activation pattern for maintaining a pinch may be substantially the same regardless of the direction of wrist movement. By fusing the EMG data (which identifies the pinch configuration and thus the zone) with the IMU data (which identifies the direction, axis, temporal profile, and kinematics of the wrist or arm movement as captured by the IMU within sensor housing 1806), the classification algorithm may resolve these ambiguities in a single inference pass.

In some aspects, the processor may employ specific disambiguation logic to distinguish between gesture types that produce similar sensor signatures. For example, the scroll gesture depicted in FIG. 20B and the rotation gesture depicted in FIG. 20C both involve maintaining a pinch while moving the wrist, but the scroll gesture produces a short, sharp angular velocity spike primarily along the pitch axis (wrist flexion/extension) with a duration of less than approximately 200 milliseconds, whereas the rotation gesture produces sustained angular velocity primarily along the roll axis (wrist pronation/supination) over a duration of greater than approximately 300 milliseconds. The classification algorithm may distinguish between the two gestures based on which IMU axis exhibits the dominant angular velocity and on the temporal duration of the angular velocity signal.

In another example, the scroll gesture of FIG. 20B and the depth exploration gesture both involve maintaining a pinch while moving, but the scroll gesture produces angular velocity (detected by the gyroscope) whereas the depth exploration gesture produces linear acceleration along a forward axis (detected by the accelerometer) without significant angular velocity. In another example, the translation gesture of FIG. 20A and the depth exploration gesture may both produce linear acceleration, but the translation gesture may produce acceleration along any combination of axes while the depth exploration gesture produces acceleration primarily along the forward (z) axis; the classification algorithm may distinguish between the two based on the ratio of z-axis acceleration to total acceleration magnitude.

In another example, the zoom gesture depicted in FIG. 24 and a simple release of the full-hand pinch may both involve a decline in EMG amplitude, but the zoom gesture produces a substantially simultaneous decline across all compartments within a defined transition window, whereas a simple release or a transition to a smaller pinch produces a sequential decline in which individual compartments deactivate at different times.

In another example, a double-tap selection gesture and a momentary loss of pinch during another gesture may both involve a brief interruption in the EMG co-activation pattern. The classification algorithm may distinguish between the two by requiring that a double-tap comprise two co-activation events separated by a release period of at least 50 milliseconds and at most 400 milliseconds, wherein each co-activation event has a duration of at least 30 milliseconds. A single brief release that does not meet these timing criteria may be classified as noise or an accidental release rather than a selection gesture.

In some aspects, XR UI module 101 may provide feedback to the user to indicate which virtual zone the user is currently operating in and to confirm the detection of gestures. The feedback may be visual, auditory, haptic, or any combination thereof. In some aspects, visual feedback may comprise highlighting or visually distinguishing the virtual zone corresponding to the detected pinch configuration on the extended reality user interface.

For example, when wristband 1802 detects a two-finger pinch corresponding to zone 2 (e.g., as shown in FIG. 19), XR UI module 101 may apply a visual emphasis (e.g., a glow, a color change, a border highlight, or an increase in opacity) to zone 2 on the extended reality user interface, thereby confirming to the user that zone 2 is the active zone. When the user transitions to a three-finger pinch corresponding to zone 4 (e.g., as shown in FIG. 21), the visual emphasis may shift from zone 2 to zone 4 in real time.

In some aspects, auditory feedback may comprise outputting a distinct audio tone, click, or chime associated with each zone when the corresponding pinch configuration is detected. For example, each zone may be assigned a unique auditory signature (e.g., a different pitch or timbre) such that the user may identify the active zone without looking at the extended reality user interface.

In some aspects, haptic feedback may be provided by one or more vibration motors embedded in wristband 1802. For example, wristband 1802 may produce a short vibration pulse when a pinch configuration is detected and classified, a different vibration pattern when a gesture is successfully executed (e.g., a scroll as shown in FIG. 20B or a rotation as shown in FIG. 20C is completed), and a distinct vibration pattern (e.g., a double pulse) when the user attempts an unrecognized gesture or transitions between zones. In some aspects, the haptic feedback pattern may differ based on the identified zone, such that the user may distinguish which zone has been activated by the tactile sensation alone. In some aspects, the visual, auditory, and haptic feedback may be combined such that a zone transition produces a concurrent visual highlight, an auditory chime, and a haptic pulse, thereby providing multi-modal confirmation of the zone change.

In some aspects, XR UI module 101 may be configured to receive user inputs from multiple input modalities and to transition between input modalities dynamically based on the user's context, environment, or preference. For example, a user may initially interact with the extended reality user interface using a camera-based detection system in which the camera identifies a surface (e.g., detected surface 1401) and detects gestures performed on the surface, as described in connection with FIGS. 13, 14, and 16.

During this initial interaction, the user may be seated at a desk and may prefer the precision of physically tapping on a flat surface. Suppose that the user subsequently stands up and begins moving through the physical environment. XR UI module 101 may detect that the previously identified surface is no longer accessible (e.g., by determining that the surface is no longer visible in image frames received from the camera or that the distance between the user and the surface exceeds a threshold). In response, XR UI module 101 may transition the input modality from camera-based surface detection to wristband-based gesture detection using wristband 1802. Wristband 1802 may already be worn by the user and may be in a standby mode in which EMG sensors 1804 and the IMU within sensor housing 1806 are active but the processor is not transmitting input events to the extended reality device.

Upon transition, the processor may begin transmitting structured input events to the extended reality device 100 and/or computing device 200, and the user may continue interacting with the same extended reality user interface—including the same plurality of virtual zones and the same plurality of selectable elements—using the pinch-based gesture set described herein (e.g., as shown in FIGS. 19-24). The transition may be seamless such that the state of the extended reality user interface (e.g., the currently selected element, the current scroll position in each zone, the currently active application) is preserved across the input modality change.

In some aspects, the transition may be initiated automatically by XR UI module 101 in response to detecting a loss of the surface or a change in the user's posture. In some aspects, the transition may be initiated manually by the user (e.g., by performing a predefined gesture such as the full-hand pinch of FIG. 22 and holding the pinch for a threshold duration). In some aspects, both input modalities may be active concurrently, and XR UI module 101 may prioritize one modality over the other based on a confidence score associated with each detected gesture. For example, if both the camera and wristband 1802 detect a gesture simultaneously, XR UI module 101 may execute the interaction action associated with the gesture that has a higher classification confidence score.

In some aspects, the wearable device may be a device other than wristband 1802. For example, the wearable device may be a ring or a series of rings worn on one or more fingers of the user. A ring may comprise one or more IMU sensors (e.g., a three-axis accelerometer and a three-axis gyroscope) configured to detect the motion and orientation of the finger on which the ring is worn.

In some aspects, a single ring may be worn on a finger and the ring may detect tap gestures (e.g., by detecting an impact signature on the accelerometer when the finger strikes a surface or another finger), scroll gestures (e.g., by detecting angular velocity along a pitch axis when the finger moves up or down), and rotation gestures (e.g., by detecting angular velocity along a roll axis when the finger rotates). In some aspects, a series of rings may be worn on multiple fingers, and each ring may be associated with a respective virtual zone. For example, a ring on the index finger may be associated with zone 2, a ring on the middle finger may be associated with zone 3, a ring on the ring finger may be associated with zone 4, and a ring on the thumb may be associated with primary zone 1. The zone may be identified based on which ring detects the initiating gesture (e.g., a tap or a motion), and the gesture type may be determined based on the motion data captured by the IMU of the active ring.

In some aspects, when a series of rings is used, the multi-finger pinch configurations described herein (e.g., as shown in FIGS. 19, 21, 22, and 23) may still be employed, and the rings may supplement the EMG-based detection by providing additional IMU data from each individual finger, thereby increasing the dimensionality of the sensor data available to the classification algorithm and improving classification accuracy.

In some aspects, the wearable device may be a glove comprising embedded EMG sensors, IMU sensors, or both, distributed across the hand and fingers of the user. The techniques described herein for zone identification, gesture classification, sensor fusion, gesture disambiguation, and feedback may be applied to any such wearable device with appropriate adaptation of the sensor placement and classification model.

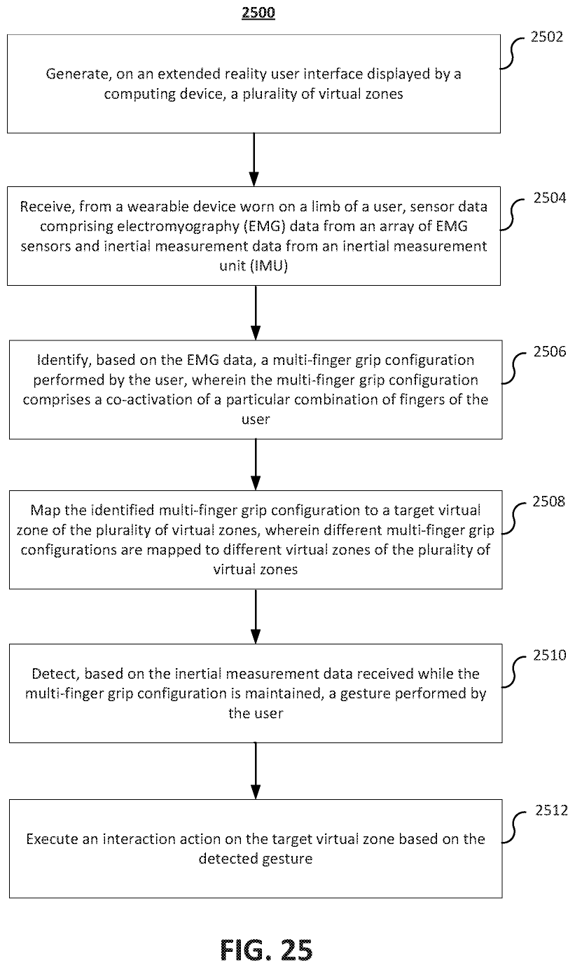

FIG. 25 illustrates a flow diagram of a method 2500 for generating and enabling interaction with an extended reality user interface using a wearable device (e.g., wristband 1802). Method 2500 may be performed by XR UI module 101 in conjunction with wristband 1802 and computing device 200 and/or extended reality device 100.

At 2502, XR UI module 101 generates, on an extended reality user interface displayed by a computing device (e.g., computing device 200 or extended reality device 100), a plurality of virtual zones. For example, the extended reality user interface may include primary zone 1, zone 2, zone 3, and zone 4, as described in connection with FIG. 4. Each virtual zone may correspond to a different functional area of the extended reality application, such that different interaction actions are deferred to different zones.

At 2504, XR UI module 101 receives, from a wearable device (e.g., wristband 1802) worn on a limb of a user, sensor data comprising EMG data from an array of EMG sensors (e.g., EMG sensors 1804) and inertial measurement data from an IMU (e.g., located within sensor housing 1806). As described in connection with FIG. 18, EMG sensors 1804 are positioned circumferentially around a volar and lateral portion of wristband 1802 in contact with skin overlying the forearm flexor musculature of the user, and the IMU includes a three-axis accelerometer and a three-axis gyroscope oriented such that a pitch axis corresponds to wrist flexion and extension, a roll axis corresponds to wrist pronation and supination, and a yaw axis corresponds to wrist radial and ulnar deviation.

At 2506, XR UI module 101 identifies, based on the EMG data, a multi-finger grip configuration performed by the user, wherein the multi-finger grip configuration comprises a co-activation of a particular combination of fingers of the user. Because each finger of the user's hand is controlled by a distinct set of muscles in the forearm, the co-activation of different combinations of fingers produces distinguishable electromyographic signatures that EMG sensors 1804 may detect. The processor within sensor housing 1806 may classify the number and identity of co-activated fingers to determine the multi-finger grip configuration.

In some aspects, the multi-finger grip configuration identified at 2506 may be a first multi-finger grip configuration comprising a co-activation of a thumb and an index finger (e.g., the two-finger pinch gesture depicted in FIG. 19). When EMG sensors 1804 detect co-activation of the flexor pollicis brevis (associated with the thumb) and the index compartment of the flexor digitorum superficialis (associated with the index finger), and no additional finger compartments exhibit co-activation above a classification threshold, the processor may classify the detected configuration as a two-finger pinch. XR UI module 101 may further identify, based on the EMG data, a second multi-finger grip configuration comprising a co-activation of the thumb, the index finger, and a middle finger (e.g., the three-finger pinch gesture depicted in FIG. 21). When EMG sensors 1804 detect co-activation of the flexor pollicis brevis, the index compartment of the flexor digitorum superficialis, and the middle compartment of the flexor digitorum superficialis, and no additional finger compartments exhibit co-activation above the classification threshold, the processor may classify the detected configuration as a three-finger pinch.

At 2508, XR UI module 101 maps the identified multi-finger grip configuration to a target virtual zone of the plurality of virtual zones, wherein different multi-finger grip configurations are mapped to different virtual zones of the plurality of virtual zones. For example, as described in connection with FIGS. 19, 21, and 22, the two-finger pinch may be mapped to zone 2 (e.g., the left navigation zone), the three-finger pinch may be mapped to zone 4 (e.g., the interaction proxies zone), the four-finger pinch may be mapped to zone 3 (e.g., the right navigation zone), and the full-hand pinch may be mapped to primary zone 1.

In some aspects, the first multi-finger grip configuration (e.g., the two-finger pinch) is mapped to a first virtual zone (e.g., zone 2), and the second multi-finger grip configuration (e.g., the three-finger pinch) is mapped to a second virtual zone (e.g., zone 4) that is different from the first virtual zone. In this manner, each progressively larger multi-finger grip configuration that includes an additional co-activated finger is mapped to a different virtual zone of the plurality of virtual zones. Zone discrimination is achieved not by identifying a spatial position of a touch on a physical or virtual surface, but by identifying the number of co-activated fingers in the grip configuration.

In some aspects, in response to identifying the multi-finger grip configuration at 2506, XR UI module 101 may provide feedback to the user indicating the target virtual zone. The feedback may comprise one or more of: a visual emphasis applied to the target virtual zone on the extended reality user interface (e.g., a glow, a color change, a border highlight, or an increase in opacity applied to the target zone), an auditory tone associated with the target virtual zone (e.g., each zone may be assigned a unique auditory signature, such as a different pitch or timbre, such that the user may identify the active zone without looking at the extended reality user interface), and a haptic vibration pattern produced by the wearable device (e.g., wristband 1802 may produce a short vibration pulse when a grip configuration is detected and classified, with the haptic feedback pattern differing based on the identified zone such that the user may distinguish which zone has been activated by the tactile sensation alone). In some aspects, the visual, auditory, and haptic feedback may be combined such that a zone transition produces a concurrent visual highlight, an auditory chime, and a haptic pulse, thereby providing multi-modal confirmation of the zone change.

At 2510, XR UI module 101 detects, based on the inertial measurement data received while the multi-finger grip configuration is maintained, a gesture performed by the user.

In some aspects, the gesture detected at 2510 is a scroll gesture. Detecting the scroll gesture may comprise detecting, via the IMU, an angular velocity spike along a pitch axis exceeding a threshold magnitude within a threshold duration. For example, the IMU within sensor housing 1806 may detect the scroll gesture as a sharp angular velocity spike along the pitch axis (e.g., exceeding a flick threshold of 150 degrees per second) followed by a deceleration as the wrist comes to rest, as described in connection with FIG. 20B. The duration of the angular velocity spike may be short (e.g., less than 200 milliseconds), which distinguishes the scroll gesture from a slower, sustained wrist rotation that may instead be classified as a rotation gesture.

In some aspects, the gesture detected at 2510 is a rotation gesture. Detecting the rotation gesture may comprise detecting, via the IMU, sustained angular velocity along a roll axis or a yaw axis while the EMG data confirms that the multi-finger grip configuration is maintained. Unlike the scroll gesture, which produces a short, sharp angular velocity spike primarily along the pitch axis, the rotation gesture produces a more gradual and sustained angular velocity primarily along the roll axis or the yaw axis over a longer duration (e.g., greater than 300 milliseconds), as described in connection with FIG. 20C.

In some aspects, the gesture detected at 2510 is a selection gesture. Detecting the selection gesture may comprise detecting, via the EMG data, a release of the multi-finger grip configuration followed by two successive re-engagements of the multi-finger grip configuration within a defined time window. For example, EMG sensors 1804 may detect two temporally separated co-activation events within a defined time window (e.g., within 400 milliseconds), and the processor may classify the gesture as a double-tap selection gesture. Each co-activation event may have a duration of at least 30 milliseconds, and the release period between the two co-activation events may be at least 50 milliseconds, to distinguish the double-tap from a momentary signal fluctuation or an accidental loss of grip contact.

In some aspects, the gesture detected at 2510 is a zoom gesture. Detecting the zoom gesture may comprise detecting, via the EMG data, a substantially simultaneous decline in EMG amplitude across all co-activated finger compartments from a sustained co-activation state to respective relaxation thresholds within a defined transition window. For example, as described in connection with FIG. 24, the user may transition from a grip configuration (e.g., the full-hand pinch of FIG. 22) to an open-hand configuration in which all fingers are extended and spread apart. The processor may classify the gesture as a zoom-out gesture based on detecting that the EMG amplitude across all active compartments decreases below respective relaxation thresholds within a defined transition window (e.g., within 500 milliseconds), and that the decline occurs substantially simultaneously across all compartments rather than sequentially. A sequential decline —in which one compartment deactivates significantly before the others—may instead be classified as a transition from one grip configuration to a smaller grip configuration (e.g., transitioning from primary zone 1 to zone 3), rather than a zoom-out gesture.

In some aspects, the processor within sensor housing 1806 may employ a classification algorithm to jointly infer a gesture-zone pair from the time-synchronized EMG and IMU data streams. The classification algorithm may be a machine-learning model such as a recurrent neural network, a hidden Markov model, a convolutional neural network, or a support vector machine trained on labeled gesture samples. The gesture-zone pair may comprise the target virtual zone and the detected gesture, and the joint inference may resolve ambiguities that either sensor modality would face in isolation. The wearable device may transmit, to the computing device, a structured input event comprising the gesture-zone pair. In this configuration, the computing device may execute the interaction action based on the structured input event without performing image processing or camera-based gesture recognition.

At 2512, XR UI module 101 executes an interaction action on the target virtual zone based on the detected gesture.

In aspects where the gesture is a scroll gesture, executing the interaction action may comprise sliding a plurality of selectable elements displayed in the target virtual zone along a vertical axis in a direction corresponding to a direction of the angular velocity spike. For example, a positive pitch angular velocity corresponding to upward wrist flexion may be classified as a scroll-up gesture, and XR UI module 101 may slide the selectable elements upward. The scroll distance or speed may be proportional to the peak angular velocity of the flick, such that a faster flick produces a longer or faster scroll.

In aspects where the gesture is a rotation gesture, executing the interaction action may comprise rotating an element displayed in the target virtual zone in a direction and by an amount indicated by an angular displacement measured by the IMU. For example, XR UI module 101 may rotate the element in the corresponding virtual zone in the direction and by the angular amount indicated by the angular displacement measured by the IMU, as described in connection with FIG. 20C.

In aspects where the gesture is a selection gesture, executing the interaction action may comprise selecting an element currently within a fixed visual indicator of the target virtual zone. In response to detecting the double-tap selection gesture, XR UI module 101 may select the element currently within the fixed visual indicator (e.g., visual identifier 1024) of the corresponding virtual zone and may generate an output view associated with the selected element in primary zone 1, in a manner consistent with the selection behavior described in connection with FIGS. 10B-10D.

In aspects where the gesture is a zoom gesture, executing the interaction action may comprise applying a zoom-out action to an element displayed in the target virtual zone, wherein a magnitude of the zoom-out action is proportional to a rate of the decline in EMG amplitude. For example, a rapid grip-to-open transition may produce a larger zoom increment than a slow transition, enabling the user to control the zoom speed by controlling the speed at which the fingers extend or close. XR UI module 101 may apply the zoom-in or zoom-out action to the main focal element displayed in primary zone 1 in a manner consistent with the enlarge and shrink interactions described in connection with motion 932 and FIG. 9E.

In some aspects, prior to receiving sensor data from the wearable device, XR UI module 101 may receive user inputs via a camera-based detection system that detects gestures performed on a physical surface (e.g., detected surface 1401 as described in connection with FIGS. 14 and 16). For example, a user may initially interact with the extended reality user interface by tapping on a flat surface detected by a camera of extended reality device 100. XR UI module 101 may subsequently detect that the physical surface is no longer accessible—for example, by determining that the surface is no longer visible in image frames received from the camera or that the distance between the user and the surface exceeds a threshold. In response to detecting that the physical surface is no longer accessible, XR UI module 101 may transition an input modality from the camera-based detection system to the wearable device (e.g., wristband 1802), wherein a state of the extended reality user interface is preserved across the transition. For example, the currently selected element, the current scroll position in each zone, and the currently active application may be maintained such that the user may continue interacting with the same extended reality user interface seamlessly. In some aspects, the transition may be initiated automatically by XR UI module 101 in response to detecting a loss of the surface, or may be initiated manually by the user, such as by performing a predefined gesture (e.g., the full-hand pinch of FIG. 22) and holding the gesture for a threshold duration.

In some aspects, rather than requiring the user to form a specific multi-finger pinch configuration to select a target virtual zone, the wearable device (e.g., wristband 1802) may enable the user to interact with the extended reality user interface using open-hand, free-space gestures in which the user reaches, points, sweeps, or otherwise moves the hand and arm through three-dimensional space toward and across the virtual zones without touching any physical or virtual surface and without adopting a predefined grip posture. In this approach, zone discrimination is achieved not by identifying a pinch configuration (as described in connection with FIGS. 19, 21, 22, and 23) or by identifying a touch location on a surface (as described in connection with FIGS. 13, 14, and 16), but by determining the spatial orientation and positional trajectory of the user's forearm and hand relative to the extended reality user interface using inertial measurement data from the IMU within sensor housing 1806.

For example, the IMU may track the orientation of the user's forearm in real time by integrating angular velocity data from the gyroscope along the pitch, roll, and yaw axes and by monitoring gravitational reference data from the accelerometer. XR UI module 101 may establish a spatial correspondence between the orientation of the forearm and the positions of the virtual zones on the extended reality user interface. Because the four-zone user interface arranges zones in a symmetric spatial layout (e.g., left, right, up, and down as described in connection with FIG. 4), the user may direct the hand toward a particular zone by orienting the forearm in a corresponding direction—for example, directing the hand to the left to target zone 2, to the right to target zone 3, upward to target primary zone 1, and downward to target zone 4. The IMU may detect the direction in which the forearm is oriented and XR UI module 101 may map the detected orientation to the spatially corresponding virtual zone. In some aspects, XR UI module 101 may define angular boundaries for each zone based on a calibrated neutral position (e.g., the forearm pointing straight ahead), such that angular displacement to the left beyond a first threshold maps to zone 2, angular displacement to the right beyond a second threshold maps to zone 3, and so on.

In some aspects, while the forearm orientation identifies the target zone, the gesture type may be determined based on a combination of hand-shape data derived from EMG sensors 1804 and motion dynamics derived from the IMU. Because the forearm muscles that control finger position produce distinct electromyographic signatures depending on whether the hand is open, closed, pointing with a single finger, or shaped in any other configuration, EMG sensors 1804 may detect the hand shape without requiring a camera to observe the hand visually. For example, EMG sensors 1804 may detect a pointing configuration (e.g., the index finger extended while remaining fingers are curled) based on isolated activation of the extensor indicis and the index compartment of the extensor digitorum, with concurrent low activation in the middle, ring, and little finger compartments. The pointing configuration may be interpreted as a selection-readiness state, in which the user is aiming at a particular element within the target zone.

In some aspects, the user may perform a free-space swipe gesture by extending the hand in an open-palm configuration and sweeping the arm laterally, vertically, or along the depth axis while the forearm is oriented toward a target zone. The IMU may detect the swipe as a sustained linear acceleration along the axis of motion (e.g., lateral acceleration for a left-to-right or right-to-left swipe, vertical acceleration for an upward or downward swipe, or forward-axis acceleration for a push or pull along the depth axis), and EMG sensors 1804 may confirm that the hand remains in the open-palm configuration throughout the motion by detecting sustained low-level co-activation across all extensor compartments. XR UI module 101 may interpret the swipe gesture as a scroll, list navigation, or depth traversal action within the target zone, depending on the axis of motion and the functionality currently assigned to the target zone—in a manner consistent with the motions described in connection with FIGS. 9A-9E. For example, a lateral swipe while the forearm is oriented toward zone 2 may correspond to motion 924 or motion 922 for navigating across applications, and a vertical swipe while the forearm is oriented toward zone 3 may correspond to motion 906 for scrolling a list.

In some aspects, the user may perform a free-space grab gesture by transitioning the hand from an open-palm configuration to a closed-fist configuration while the forearm is directed toward primary zone 1. EMG sensors 1804 may detect the grab as a rapid increase in EMG amplitude across all flexor compartments, transitioning from the low-activation open-palm state to a high-activation closed-fist state within a defined transition window (e.g., within 400 milliseconds). Once the grab is detected, the user may move the arm to reposition, rotate, or scale the grabbed element in primary zone 1. For example, translating the arm while in the closed-fist configuration may reposition the element, rotating the wrist may rotate the element (as detected by angular velocity along the roll or yaw axis of the IMU), and pulling the arm backward or pushing it forward may scale the element larger or smaller, respectively, as detected by sustained linear acceleration along the forward axis of the IMU. XR UI module 101 may release the element when EMG sensors 1804 detect a transition back to the open-palm configuration (e.g., a rapid decline in flexor compartment activation). These interactions correspond to the manipulation functionality described in connection with motion 932 and FIG. 9E but are executed entirely in free space without the user touching any surface.

In some aspects, the user may perform a free-space push gesture to interact with elements along the depth axis of the extended reality user interface. The push gesture may involve the user extending the arm forward in a thrusting motion while maintaining an open-palm configuration with the hand oriented toward the target zone. The IMU may detect the push gesture as a rapid positive linear acceleration along the forward (z) axis followed by a deceleration, and EMG sensors 1804 may confirm the open-palm hand shape throughout the motion. XR UI module 101 may interpret the push gesture as a navigation action that traverses deeper into a hierarchical menu or selects an element by “pushing” it into focus, consistent with the depth navigation described in connection with shift 915 in FIG. 9B. Conversely, a pull gesture—in which the user retracts the arm backward in a pulling motion while maintaining the open-palm configuration—may be interpreted as a navigation action that returns to a previous hierarchical level or pulls an element forward along the depth axis. The distinction between push and pull may be based on the sign of the linear acceleration detected by the accelerometer along the forward axis.

In some aspects, the processor within sensor housing 1806 may distinguish the free-space gestures described above from the pinch-based gestures described in connection with FIGS. 19-24 based on the EMG signature of the hand configuration at the time of gesture initiation. When the processor detects a multi-finger pinch co-activation pattern (e.g., co-activation of flexor compartments consistent with a two-finger, three-finger, four-finger, or full-hand pinch), the processor may route the gesture to the pinch-based gesture classification pipeline. When the processor instead detects an EMG pattern consistent with an open-hand configuration (e.g., dominant activation in extensor compartments with low flexor co-activation) or a pointing configuration (e.g., isolated extensor indicis activation), the processor may route the gesture to the free-space gesture classification pipeline. This enables both gesture paradigms to coexist on the same wearable device, and the user may fluidly transition between pinch-based zone selection and free-space spatial interaction depending on preference, context, or the nature of the interaction being performed.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating and enabling interaction with an extended reality user interface using a wearable device, the method comprising:
generating, on an extended reality user interface displayed by a computing device, a plurality of virtual zones;
receiving, from a wearable device worn on a limb of a user, sensor data comprising electromyography (EMG) data from an array of EMG sensors and inertial measurement data from an inertial measurement unit (IMU);
identifying, based on the EMG data, a multi-finger grip configuration performed by the user, wherein the multi-finger grip configuration comprises a co-activation of a particular combination of fingers of the user;
mapping the identified multi-finger grip configuration to a target virtual zone of the plurality of virtual zones, wherein different multi-finger grip configurations are mapped to different virtual zones of the plurality of virtual zones;
detecting, based on the inertial measurement data received while the multi-finger grip configuration is maintained, a gesture performed by the user; and
executing an interaction action on the target virtual zone based on the detected gesture.

2. The method of claim 1, wherein the multi-finger grip configuration is a first multi-finger grip configuration comprising a co-activation of a thumb and an index finger, and the target virtual zone is a first virtual zone, and wherein the method further comprises:
identifying, based on the EMG data, a second multi-finger grip configuration comprising a co-activation of the thumb, the index finger, and a middle finger; and
mapping the second multi-finger grip configuration to a second virtual zone of the plurality of virtual zones that is different from the first virtual zone.

3. The method of claim 1, wherein each progressively larger multi-finger grip configuration that includes an additional co-activated finger is mapped to a different virtual zone of the plurality of virtual zones.

4. The method of claim 1, wherein the gesture is a scroll gesture, and wherein detecting the gesture comprises:
detecting, via the IMU, an angular velocity spike along a pitch axis exceeding a threshold magnitude within a threshold duration, and
wherein executing the interaction action comprises sliding a plurality of selectable elements displayed in the target virtual zone along a vertical axis in a direction corresponding to a direction of the angular velocity spike.

5. The method of claim 1, wherein the gesture is a rotation gesture, and wherein detecting the gesture comprises:
detecting, via the IMU, sustained angular velocity along a roll axis or a yaw axis while the EMG data confirms that the multi-finger grip configuration is maintained, and
wherein executing the interaction action comprises rotating an element displayed in the target virtual zone in a direction and by an amount indicated by an angular displacement measured by the IMU.

6. The method of claim 1, wherein the gesture is a selection gesture, and wherein detecting the gesture comprises:
detecting, via the EMG data, a release of the multi-finger grip configuration followed by two successive re-engagements of the multi-finger grip configuration within a defined time window, and
wherein executing the interaction action comprises selecting an element currently within a fixed visual indicator of the target virtual zone.

7. The method of claim 1, wherein the gesture is a zoom gesture, and wherein detecting the gesture comprises:
detecting, via the EMG data, a substantially simultaneous decline in EMG amplitude across all co-activated finger compartments from a sustained co-activation state to respective relaxation thresholds within a defined transition window, and
wherein executing the interaction action comprises applying a zoom-out action to an element displayed in the target virtual zone, wherein a magnitude of the zoom-out action is proportional to a rate of the decline in EMG amplitude.

8. The method of claim 1, further comprising:
classifying a gesture-zone pair based on the EMG data and the inertial measurement data using a classification algorithm, wherein the gesture-zone pair comprises the target virtual zone and the detected gesture; and
transmitting, from the wearable device to the computing device, a structured input event comprising the gesture-zone pair,
wherein the computing device executes the interaction action based on the structured input event without performing image processing or camera-based gesture recognition.

9. The method of claim 1, further comprising:
in response to identifying the multi-finger grip configuration, providing feedback to the user indicating the target virtual zone, wherein the feedback comprises one or more of: a visual emphasis applied to the target virtual zone on the extended reality user interface, an auditory tone associated with the target virtual zone, and a haptic vibration pattern produced by the wearable device.

10. The method of claim 1, further comprising:
prior to receiving the sensor data from the wearable device, receiving user inputs via a camera-based detection system that detects gestures performed on a physical surface;
detecting that the physical surface is no longer accessible; and
in response to detecting that the physical surface is no longer accessible, transitioning an input modality from the camera-based detection system to the wearable device, wherein a state of the extended reality user interface is preserved across the transition.

11. A system for generating and enabling interaction with an extended reality user interface, comprising:
at least one memory; and
at least one hardware processor coupled with the at least one memory and configured, individually or in combination, to:
generate, on an extended reality user interface displayed by a computing device, a plurality of virtual zones;
receive, from a wearable device worn on a limb of a user, sensor data comprising electromyography (EMG) data from an array of EMG sensors and inertial measurement data from an inertial measurement unit (IMU);
identify, based on the EMG data, a multi-finger grip configuration performed by the user, wherein the multi-finger grip configuration comprises a co-activation of a particular combination of fingers of the user;
map the identified multi-finger grip configuration to a target virtual zone of the plurality of virtual zones, wherein different multi-finger grip configurations are mapped to different virtual zones of the plurality of virtual zones;
detect, based on the inertial measurement data received while the multi-finger grip configuration is maintained, a gesture performed by the user; and
execute an interaction action on the target virtual zone based on the detected gesture.

12. The system of claim 11, wherein the multi-finger grip configuration is a first multi-finger grip configuration comprising a co-activation of a thumb and an index finger, and the target virtual zone is a first virtual zone, and wherein the at least one hardware processor is further configured to:
identify, based on the EMG data, a second multi-finger grip configuration comprising a co-activation of the thumb, the index finger, and a middle finger; and
map the second multi-finger grip configuration to a second virtual zone of the plurality of virtual zones that is different from the first virtual zone.

13. The system of claim 11, wherein each progressively larger multi-finger grip configuration that includes an additional co-activated finger is mapped to a different virtual zone of the plurality of virtual zones.

14. The system of claim 11, wherein the gesture is a scroll gesture, and wherein the at least one hardware processor is further configured to detect the gesture by:
detecting, via the IMU, an angular velocity spike along a pitch axis exceeding a threshold magnitude within a threshold duration, and
wherein executing the interaction action comprises sliding a plurality of selectable elements displayed in the target virtual zone along a vertical axis in a direction corresponding to a direction of the angular velocity spike.

15. The system of claim 11, wherein the gesture is a rotation gesture, and wherein the at least one hardware processor is further configured to detect the gesture by:
detecting, via the IMU, sustained angular velocity along a roll axis or a yaw axis while the EMG data confirms that the multi-finger grip configuration is maintained, and
wherein executing the interaction action comprises rotating an element displayed in the target virtual zone in a direction and by an amount indicated by an angular displacement measured by the IMU.

16. The system of claim 11, wherein the gesture is a selection gesture, and wherein the at least one hardware processor is further configured to detect the gesture by:
detecting, via the EMG data, a release of the multi-finger grip configuration followed by two successive re-engagements of the multi-finger grip configuration within a defined time window, and
wherein executing the interaction action comprises selecting an element currently within a fixed visual indicator of the target virtual zone.

17. The system of claim 11, wherein the gesture is a zoom gesture, and wherein the at least one hardware processor is further configured to detect the gesture by:
detecting, via the EMG data, a substantially simultaneous decline in EMG amplitude across all co-activated finger compartments from a sustained co-activation state to respective relaxation thresholds within a defined transition window, and
wherein executing the interaction action comprises applying a zoom-out action to an element displayed in the target virtual zone, wherein a magnitude of the zoom-out action is proportional to a rate of the decline in EMG amplitude.

18. The system of claim 11, wherein the at least one hardware processor is further configured to:
classify a gesture-zone pair based on the EMG data and the inertial measurement data using a classification algorithm, wherein the gesture-zone pair comprises the target virtual zone and the detected gesture; and
transmit, from the wearable device to the computing device, a structured input event comprising the gesture-zone pair,
wherein the computing device executes the interaction action based on the structured input event without performing image processing or camera-based gesture recognition.

19. The system of claim 11, wherein the at least one hardware processor is further configured to:
in response to identifying the multi-finger grip configuration, provide feedback to the user indicating the target virtual zone, wherein the feedback comprises one or more of: a visual emphasis applied to the target virtual zone on the extended reality user interface, an auditory tone associated with the target virtual zone, and a haptic vibration pattern produced by the wearable device.

20. The system of claim 11, wherein the at least one hardware processor is further configured to:
prior to receiving the sensor data from the wearable device, receive user inputs via a camera-based detection system that detects gestures performed on a physical surface;
detect that the physical surface is no longer accessible; and
in response to detecting that the physical surface is no longer accessible, transition an input modality from the camera-based detection system to the wearable device, wherein a state of the extended reality user interface is preserved across the transition.

21. A non-transitory computer readable medium storing thereon computer executable instructions for generating and enabling interaction with an extended reality user interface, including instructions for:
generating, on an extended reality user interface displayed by a computing device, a plurality of virtual zones;
receiving, from a wearable device worn on a limb of a user, sensor data comprising electromyography (EMG) data from an array of EMG sensors and inertial measurement data from an inertial measurement unit (IMU);
identifying, based on the EMG data, a multi-finger grip configuration performed by the user, wherein the multi-finger grip configuration comprises a co-activation of a particular combination of fingers of the user;
mapping the identified multi-finger grip configuration to a target virtual zone of the plurality of virtual zones, wherein different multi-finger grip configurations are mapped to different virtual zones of the plurality of virtual zones;
detecting, based on the inertial measurement data received while the multi-finger grip configuration is maintained, a gesture performed by the user; and
executing an interaction action on the target virtual zone based on the detected gesture.
